(19) United States
(12) Patent Application Publication
(10) Pub. No.: US 2024/0192373 A1
(43) Pub. Date: Jun. 13, 2024

(54) Directional optical detection devices

(71) Applicant: RealD Spark, LLC, BOULDER, CO (US)

(72) Inventors: Jonathan HARROLD, Leamington Spa (GB); Michael G Robinson, Boulder, CO (US); Graham J Woodgate, Henley-on-Thames (GB)

(21) Appl. No.: 18/523,754

(22) Filed: Nov. 29, 2023

Related U.S. Application Data
(60) Provisional application No. 63/454,850, filed on Mar. 27, 2023.
(60) Provisional application No. 63/430,974, filed on Dec. 7, 2022.
(60) Provisional application No. 63/434,409, filed on Dec. 21, 2022.
(60) Provisional application No. 63/441,722, filed on Jan. 27, 2023.
(60) Provisional application No. 63/454,836, filed on Mar. 27, 2023.

(51) Int. Cl. G01S 17/89; G01S 7/481; G01S 17/931

(52) U.S. Cl. CPC G01S 17/89; G01S 7/4816; G01S 7/4818; G01S 17/931

(57) ABSTRACT

An anamorphic directional detection device comprises an array of light detectors arranged to detect light from an anamorphic optical system. The anamorphic optical system comprises a transverse anamorphic component arranged to provide optical imaging of an external scene to the array of light detectors in a transverse direction. Opposed guide surfaces are arranged to guide input light along a waveguide towards the transverse optical system from an injection reflector arranged to inject the input light. The injection reflector is a lateral anamorphic component arranged to image the external scene towards the array of detectors in a lateral direction orthogonal to the transverse direction. A thin and high efficiency directional detection device is provided that can be used for LIDAR and other light detection purposes such as cameras. A thin display apparatus comprising a high efficiency camera arranged behind a light transmitting spatial light modulator may be provided.

### TECHNICAL FIELD

This disclosure generally relates to detection of reflections from objects in a scene and for the measurement of object distances in that scene from the detector. Embodiments include detection devices for use on a vehicle for such as a light detection and ranging (LIDAR) apparatus and for cameras.

### BACKGROUND

LIDAR systems are the light-wavelength analogue of microwave RADAR systems and can be used to measure or detect properties of objects in the environment remotely. Many LIDAR systems are for remote sensing of the earth and operate from airplanes or satellites. LIDAR that operates from a terrestrial vehicle is used to detect the distance of objects from the detector for example in a road or city scene. The LIDAR wavelengths used for this are typically in the near infra-red so as not to be visible to humans but to be readily detectable by semiconductor sensors. The detection system may detect the amplitude of reflected light from the scene. Alternatively, a laser source and coherent detection system may be used. The light to illuminate the scene may be from a pulsed “flood” beam or alternatively from a scanned beam. The scanning mechanism may for example comprise rotating or oscillating mirrors or alternatively a solid-state beam deflection apparatus. For flood illumination, the detector may function like a camera and may be a two-dimensional solid-state detector array. For scanned illumination the detector may be one or more detectors whose readout is correlated with the scanning system to produce a depth map of the scene.

### BRIEF SUMMARY

According to a first aspect of the present disclosure there is provided a directional light detection device comprising: a light detection system comprising an array of light detectors distributed in a lateral direction; and an optical system arranged to input light from a remote scene and direct the input light to the light detection system, wherein the optical system comprises a waveguide that comprises: front and rear guide surfaces arranged to guide the input light along the waveguide to the light detection system; and an injection reflector arranged to reflect the input light received through at least one of the guide surfaces and inject the input light into the waveguide for guiding by the front and rear guide surfaces, wherein the injection reflector may have positive optical power in the lateral direction. A compact, high efficiency, low cost detection apparatus may be provided. The height of the light injection aperture may be reduced to advantageously achieve desirable aesthetic appearance. High collection efficiency of illuminated scenes may be achieved with high resolution detection of detected light cones in one or two dimensions. High image contrast may be achieved for high fidelity of image capture. A compact and efficient LIDAR detector or camera may be provided.

The directional light detection device may be an anamorphic directional light detection device, wherein the optical system has an optical axis and may have anamorphic properties in the lateral direction and a transverse direction that may be perpendicular to each other and perpendicular to the optical axis, and the optical system may further comprise a transverse anamorphic component having positive optical power in the transverse direction, wherein the transverse anamorphic component may be arranged to receive the light that has been guided between the front and rear guide surfaces before the light may be directed to the light detection system. Scene detection may be achieved in two dimensions with high image fidelity.

The optical system may comprise an output section comprising an output reflector that may be the transverse anamorphic component and may be arranged to reflect the light that has been guided between the front and rear guide surfaces and direct it to the light detection system.

The transverse anamorphic component may further comprise a lens. Advantageously reduced aberrations and improved fidelity for off-axis aberrations may be achieved. Contrast of detection may be increased.

The output section may further comprise an output face disposed on a front or rear side of the waveguide and facing the output reflector, the light detection system being arranged to receive light output through the output face of the output section, and the output section may be arranged to direct the light that has been guided between the front and rear guide surfaces through the output face to the light detection system. The size of the detection device may be reduced.

The output face may extend at an acute angle to the front guide surface in the case that the output face is on the front side of the waveguide or to the rear guide surface in the case that the output face is on the rear side of the waveguide. The output section may further comprise a separation face extending outwardly from the one of the front or rear guide surfaces to the output face.

Stray light may be reduced and efficiency of light capture increased.

The output face may extend parallel to the front guide surface in the case that the output face is on the front side of the waveguide or to the rear guide surface in the case that the output face is on the rear side of the waveguide. The output face may be coplanar with the front guide surface in the case that the output face is on the front side of the waveguide or with the rear guide surface in the case that the output face is on the rear side of the waveguide. The output face may be disposed outwardly of one of the front or rear guide surfaces. The complexity of the moulding of the waveguide may be reduced.

The output section may be integral with the waveguide. Complexity of moulding of the optical apparatus may be reduced, achieving reduced cost.

The waveguide may have an end that is an output face that may be arranged to output the light that has been guided between the front and rear guide surfaces, and the output section may be a separate element from the waveguide that may further comprise an input face and may be arranged to receive the light output from the waveguide through the input face. Complexity of molding of the individual optical components may be reduced, achieving increased yield.

The transverse anamorphic component may comprise a lens, that may be optionally a compound lens. Off-axis aberrations may be improved. Reduced aberrations may be advantageously achieved.

The waveguide may have an end that may be an output face that is arranged to output the light that has been guided between the front and rear guide surfaces, the light detection system being arranged to receive the light output through the output face of the waveguide. Complexity of the moulding of the waveguide may be reduced.

The transverse anamorphic component may be disposed outside the waveguide, and the light detection system may be arranged to direct light towards the waveguide through the transverse anamorphic component.

The direction of the optical axis through the transverse anamorphic component may be inclined at an acute angle with respect to the front and rear guide surfaces of the waveguide. The output face may be inclined at an acute angle with respect to the front and rear guide surfaces of the waveguide. The detected light cone may be provided without replicated images on the array of light detectors. Advantageously stray light may be reduced.

The optical system may have no optical power in a transverse direction that is perpendicular to the lateral direction. The complexity of the optical system and detector may be reduced, advantageously achieving reduced cost.

The waveguide may have an end that may be an output face that is arranged to output the light that has been guided between the front and rear guide surfaces, the light detection system being arranged to receive the light output through the output face of the waveguide.

The injection reflector may be an end of the waveguide. Advantageously increased efficiency may be achieved. Complexity and cost of fabrication may be reduced. An emitting aperture with small height may be achieved, advantageously achieving desirable aesthetic appearance.

At least one of an output face, the transverse anamorphic component and the array of light detectors may have a curvature in the lateral direction that compensates for field curvature of the injection reflector. Advantageously the uniformity of the fidelity of optical cones may be increased across the field of output of the detection device.

The front and rear guide surfaces of the waveguide may be planar and parallel. Advantageously fidelity of light cones may be improved.

The array of light detectors may also be distributed in the transverse direction. The array of light detectors have pitches in the lateral and transverse directions with a ratio that may be the same as the inverse of the ratio of optical powers of the lateral and transverse anamorphic optical elements. The light cones may have substantially the same sizes in the lateral and transverse directions.

The injection reflector may be arranged to reflect the input light received through the front guide surface. Advantageously high collection efficiency may be achieved.

The directional light detection device may further comprise a light source arranged behind the rear guide surface of the waveguide to output light through the waveguide. The light source may be arranged to output infra-red light. The light detectors may be arranged to detect infra-red light. Advantageously a compact detection apparatus may be provided.

The directional light detection device may be a light detection and ranging apparatus, wherein the directional light detection device may further comprise a light source arranged to output infra-red light for illumination of the remote scene; the light detectors may be arranged to detect infra-red light; and the directional light detection device may further comprise a control system that is arranged to detect geometry of the remote scene from the light detected by the light detectors. A LIDAR detection system may be used to detect a scene geometry, for example for automotive road scene capture or for face detection and analysis.

The directional light detection device may be a camera, wherein the light detectors are arranged to capture an image. The light detectors may be arranged to capture a colour image. A low thickness camera may be provided with high capture efficiency.

According to a second aspect of the present disclosure there is provided a display apparatus comprising: a spatial light modulator that is partially transparent; and a directional light detection device of the first aspect, wherein the directional light detection device is arranged behind the spatial light modulator so that the optical system inputs light from the remote scene through the spatial light modulator. The display apparatus may detect an image through the spatial light modulator with high capture efficiency and with small added thickness. The resolution of the display apparatus at least near to the injection reflector may be increased.

Any of the aspects of the present disclosure may be applied in any combination.

Embodiments of the present disclosure may be used in a variety of optical systems. The embodiments may include or work with a variety of projectors, projection systems, optical components, displays, microdisplays, computer systems, processors, self-contained projector systems, visual and/or audiovisual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments.

Before proceeding to the disclosed embodiments in detail, it should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying FIGURES, in which like reference numbers indicate similar parts, and in which:

FIG. 1A is a schematic diagram illustrating in rear perspective view an anamorphic directional detection device comprising a waveguide with a curved reflective transverse anamorphic component and a curved reflective lateral anamorphic component;

FIG. 1B is a schematic diagram illustrating in an alternative rear perspective view the waveguide of FIG. 1A;

FIG. 1C is a schematic diagram illustrating in side view the waveguide of FIG. 1A;

FIG. 1D is a schematic diagram illustrating in front view the waveguide of FIG. 1A;

FIG. 1E is a schematic diagram illustrating in side view an alternative anamorphic directional detection device wherein the input face is arranged on the same side of the waveguide as the front surface of the waveguide;

FIG. 1F is a schematic diagram illustrating in side view an alternative arrangement of an anamorphic directional detection device comprising plural members and the waveguide;

FIG. 1G is a schematic diagram illustrating in side view an alternative arrangement of an anamorphic directional detection device wherein the front guide surface and input face are arranged on a common surface;

FIG. 1H is a schematic diagram illustrating in side view an alternative arrangement of an anamorphic directional detection device wherein the rear guide surface and output face are arranged on a common surface;

FIG. 1I is a schematic diagram illustrating in side view an alternative arrangement of an anamorphic directional detection device wherein the front guide surface and output face are inclined to each other;

FIG. 1J is a schematic diagram illustrating in side view an alternative arrangement of an anamorphic directional detection device wherein the front guide surface and output face are offset from each other;

FIG. 1K is a schematic diagram illustrating in side view an alternative arrangement of an anamorphic directional detection device comprising an alternative arrangement of separation faces;

FIG. 1L is a schematic diagram illustrating in rear perspective view an alternative arrangement of an anamorphic directional detection device wherein the waveguide region is shortened;

FIG. 1M is a schematic diagram illustrating in side view the directional detection device of FIG. 1L;

FIG. 1N is a schematic diagram illustrating in top view the directional detection device of FIG. 1L;

FIG. 2A is a schematic diagram illustrating in side view a vehicle light detector comprising: a housing for fitting to a vehicle, and a detection device mounted on the housing; and a transmissive cover extending across the first light guiding surface of the waveguide;

FIG. 2B is a schematic diagram illustrating in front view the vehicle light detector of FIG. 2A;

FIG. 2C is a schematic diagram illustrating in rear perspective view the optical input to a vehicle light detector;

FIG. 2D is a schematic diagram illustrating in side view the optical input to a vehicle light detector;

FIG. 3 is a schematic diagram illustrating in front view a light detector array for the directional detection device of FIG. 1A;

FIG. 4A is a schematic diagram illustrating in rear perspective view an anamorphic directional detection device comprising a waveguide comprising a curved reflective lateral anamorphic component that is a reflection extractor and is an end of the waveguide, and a transverse anamorphic component that is a lens;

FIG. 4B is a schematic diagram illustrating in side view a waveguide comprising a curved reflective lateral anamorphic component that is a reflection extractor and is an end of the waveguide and a transverse anamorphic component that comprises a compound lens;

FIG. 4C is a schematic diagram illustrating in front view the operation of the waveguide of FIGS. 4A-B;

FIG. 5 is a schematic diagram illustrating in front perspective view the waveguide of FIG. 4A with an alternative alignment of optical cones;

FIG. 6A is a schematic diagram illustrating in side view a multiple detector arrays arrangement for use in the anamorphic directional detection device of FIG. 4A comprising separate red, green and blue detector arrays and a beam combining element;

FIG. 6B is a schematic diagram illustrating in side view a detection system for use in the anamorphic directional detection device of FIG. 4A comprising a birdbath folded arrangement;

FIG. 7 is a schematic diagram illustrating in front perspective view an alternative arrangement of an output focussing lens;

FIG. 8 is a schematic diagram illustrating in rear perspective view a stack of waveguides arranged to provide complementary detection;

FIG. 9A is a schematic diagram illustrating in rear perspective view an anamorphic directional detection device comprising a Fresnel reflector;

FIG. 9B is a schematic diagram illustrating in rear perspective view an anamorphic directional detection device comprising a curved output face and a curved light detector array;

FIG. 10A is a schematic diagram illustrating in front view an anamorphic directional detection device wherein an output end of the waveguide has curvature in the lateral direction;

FIG. 10B is a schematic diagram illustrating in front view an anamorphic directional detection device wherein an output end of the waveguide has curvature in the lateral direction and a transverse anamorphic component has curvature in the lateral direction;

FIG. 10C is a schematic diagram illustrating in front view an anamorphic directional detection device wherein an output end of the waveguide has curvature in the lateral direction, a transverse anamorphic component has curvature in the lateral direction, and a light detector array has curvature in the lateral direction;

FIG. 10D is a schematic diagram illustrating in front view an anamorphic directional detection device wherein an output end of the waveguide has curvature in the lateral direction, a transverse anamorphic component has curvature in the lateral direction, and a light detector array has curvature in the lateral direction, where the direction of curvature is in an opposite direction to that of FIG. 10C;

FIG. 10E is a schematic diagram illustrating in front view an anamorphic directional detection device wherein an output end of the waveguide has curvature in the lateral direction, a transverse anamorphic component has curvature in the lateral direction, and a light detector array has curvature in the lateral direction, where the direction of curvature of these components is different;

FIG. 11A is a schematic diagram illustrating in side view a vehicle comprising vehicle light detectors of the present embodiments;

FIG. 11B is a schematic diagram illustrating in top view a vehicle comprising vehicle light detectors of the present embodiments;

FIG. 11C is a schematic diagram illustrating in side view part of a vehicle comprising vehicle light detectors that are mounted with tilted orientations;

FIG. 12A is a schematic diagram illustrating in front perspective view a directional detection device comprising a waveguide with a curved reflective lateral anamorphic component arranged to provide a one-dimensional array of optical cones;

FIG. 12B is a schematic diagram illustrating in side view the directional detection device of FIG. 12A;

FIG. 12C is a schematic diagram illustrating in front view the directional detection device of FIG. 12A;

FIG. 13A is a schematic diagram illustrating in rear perspective view a directional detection device comprising a waveguide with a planar reflective end and a lateral anamorphic component comprising a curved injection reflector;

FIG. 13B is a schematic diagram illustrating in side view a directional detection device comprising a waveguide with an output section comprising a planar reflective end and a waveguide comprising a lateral anamorphic component comprising a curved injection reflector;

FIG. 14A is a schematic diagram illustrating in front view a light detector array comprising contiguous columns of light emitters for use in the directional detection device of FIGS. 12A-C and FIG. 13A;

FIG. 14B is a schematic diagram illustrating in front view an alternative light detector array comprising contiguous columns of light emitters for use in the directional detection device of FIGS. 12A-C and FIG. 13A;

FIG. 14C and FIG. 14D are schematic diagrams illustrating in front view a light detector array comprising columns of overlapping light emitters for use in the directional detection device of FIGS. 12A-C and FIG. 13A;

FIG. 14E is a schematic diagram illustrating in front view an alternative light detector array comprising detector pairs;

FIG. 15A is a schematic timing diagram illustrating detected output light from a LIDAR light source;

FIG. 15B is a schematic timing diagram illustrating detected light received from a remote scene;

FIG. 15C is a schematic timing diagram illustrating the in-phase illumination light logic state;

FIG. 15D is a schematic timing diagram illustrating detected light gated (ANDed) with the in-phase illumination light logic state;

FIG. 15E is a schematic timing diagram illustrating the antiphase illumination light logic state;

FIG. 15F is a schematic timing diagram illustrating the detected light gated (ANDed) with the antiphase illumination light logic state;

FIG. 16A is a schematic diagram illustrating in front view a display apparatus comprising a directional detection device arranged behind a spatial light modulator; and

FIG. 16B is a schematic diagram illustrating in side view a display apparatus comprising a directional detection device arranged behind the spatial light modulator.

### DETAILED DESCRIPTION

The structure and operation of various directional detection devices will now be described. In this description, common elements have common reference numerals. It is noted that the disclosure relating to any element applies to each device in which the same or corresponding element is provided. Accordingly, for brevity such disclosure is not repeated.

It would be desirable to provide a directional detection device for a vehicle with adjustable detection profile by means of electronic control.

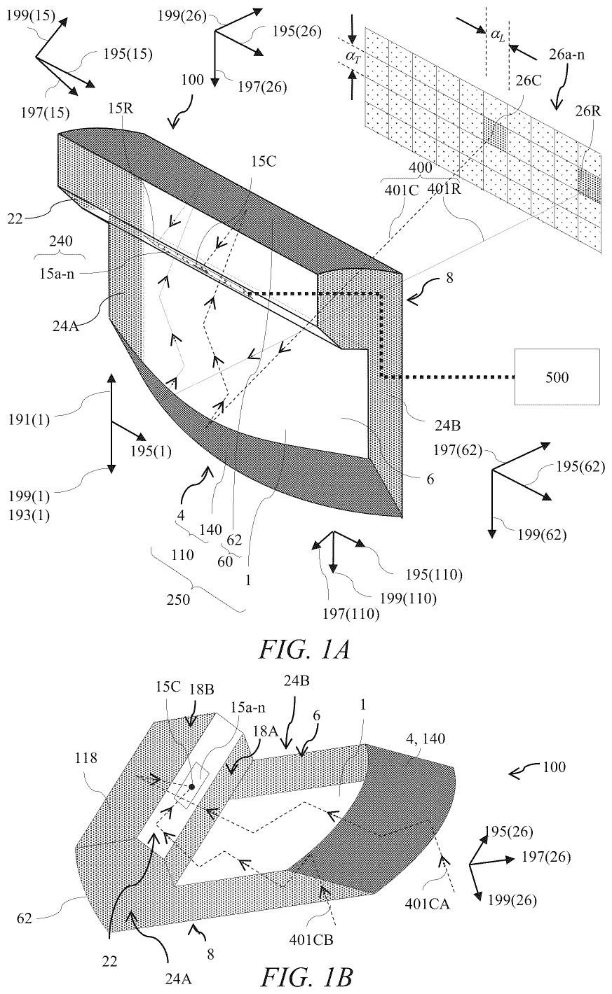

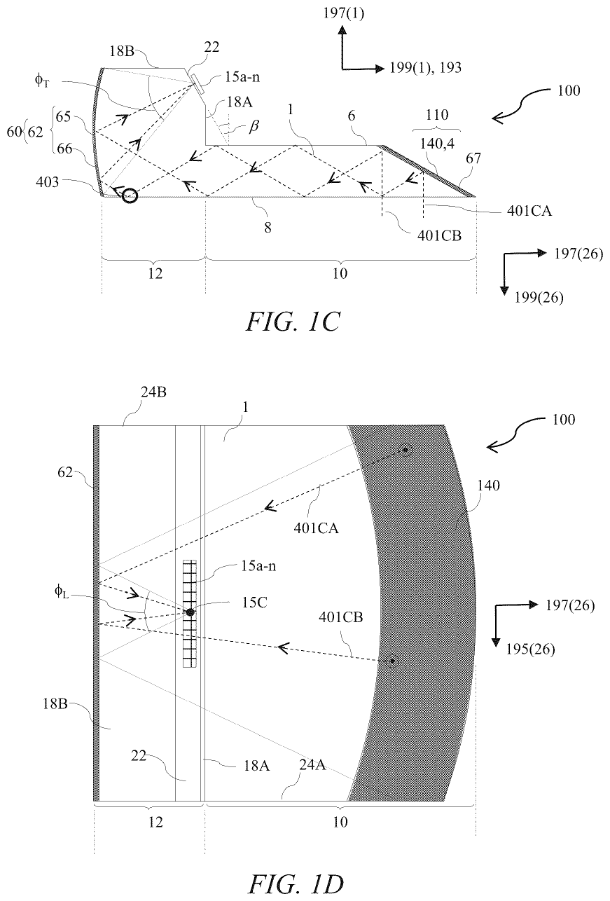

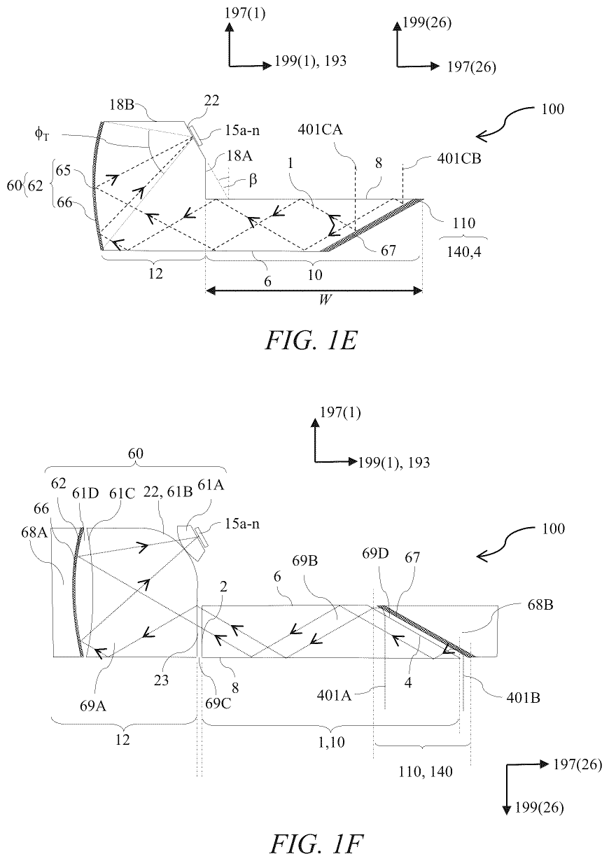

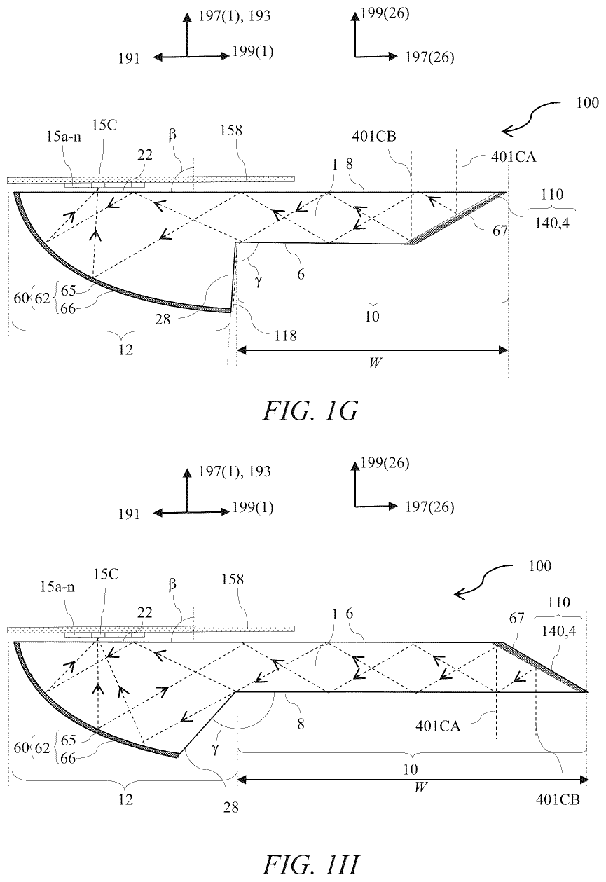

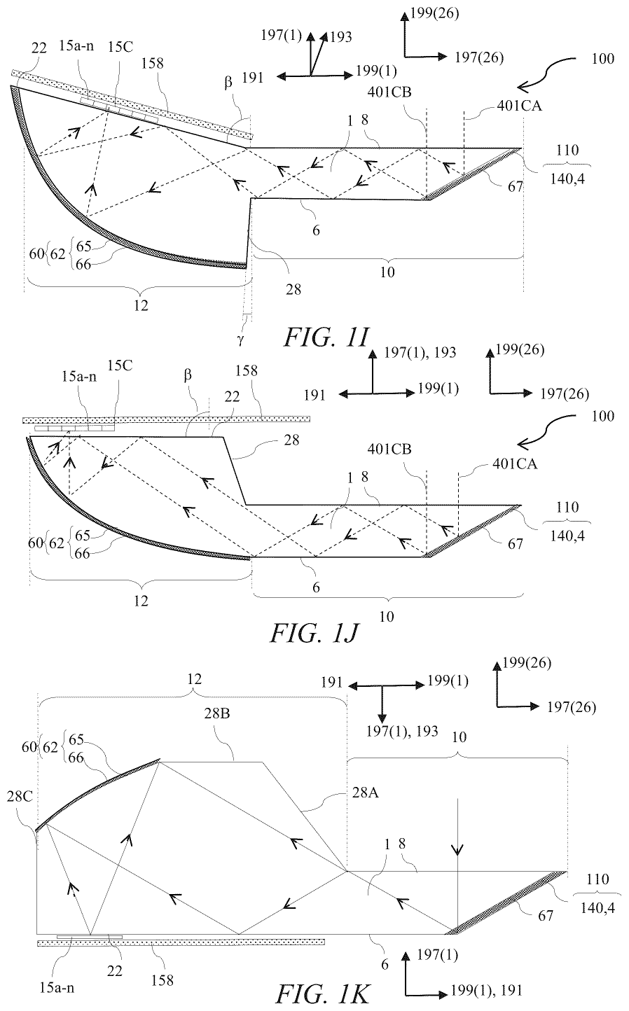

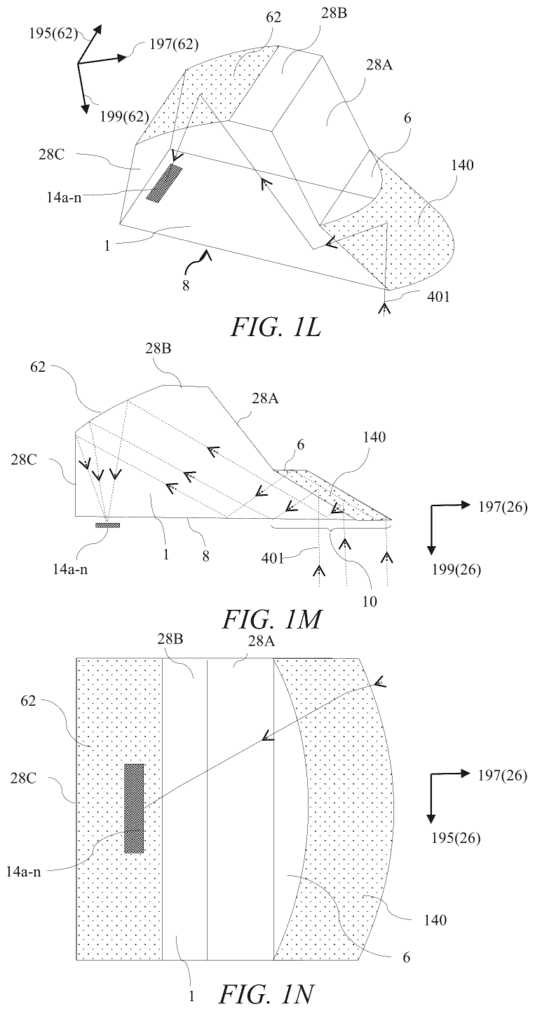

FIG. 1A is a schematic diagram illustrating in rear perspective view an anamorphic directional detection device 100 comprising a waveguide 1 with a curved reflective transverse anamorphic component 60 and a curved reflective lateral anamorphic component 110; FIG. 1B is a schematic diagram illustrating in an alternative rear perspective view the waveguide 1 of FIG. 1A; FIG. 1C is a schematic diagram illustrating in side view the waveguide 1 of FIG. 1A; and FIG. 1D is a schematic diagram illustrating in front view the waveguide 1 of FIG. 1A.

The anamorphic directional detection device 100 comprises: a detection system 240 comprising an array of light detectors 15a-n distributed in a lateral direction 195, the detection system 240 being arranged to output light 400 to the light detectors 15a-n.

Optical system 250 is arranged to direct input light input towards the detection system 240, wherein the optical system 250 has an optical axis 199 and has anamorphic properties in the lateral direction 195 and a transverse direction 197 that are perpendicular to each other and perpendicular to the optical axis 199.

Mathematically expressed, for any location within the anamorphic directional detection device 100, the optical axis direction 199 may be referred to as the O unit vector, the transverse direction 197 may be referred to as the T unit vector and the lateral direction 195 may be referred to as the L unit vector wherein the optical axis direction 199 is the crossed product of the transverse direction 197 and the lateral direction 195:

O=T×L eqn. 1

Various surfaces of the anamorphic directional detection device 100 transform or replicate the optical axis direction 199; however, for any given light ray 400 the expression of eqn. 1 may be applied.

The optical system 250 comprises: a transverse anamorphic component 60 having positive optical power in the transverse direction 197, wherein the transverse anamorphic component 60 is arranged to direct light towards the detection system 240. The transverse anamorphic component 60 in the embodiment of FIG. 1A is an output reflector 62 that is extended in a lateral direction 195(62) parallel to the lateral direction 195(15) of the array of light detectors 15a-n. The output reflector 62 has positive optical power in a transverse direction 197(62) that is parallel to the direction 197(15) and orthogonal to the lateral direction 195(62); and no optical power in the lateral direction 195(62).

The output reflector 62 may comprise a reflective material 66 provided on the curved surface 65 of the waveguide 1. The reflective material 66 may for example comprise an aluminium or silver coating and appropriate protection layers and may be applied to the surface 65 by means of evaporation, sputtering, printing or other known application methods. Alternatively the reflective material 66 may comprise a reflective film such as ESR™ from 3M corporation that is attached to a curved surface 65 of the waveguide 1.

The output reflector 62 is arranged to direct light rays 400 towards the array of light detectors 15a-n. The optical system 250 is arranged so that light output from the output reflector 62 is directed in directions that are distributed in the transverse direction 197(62).

The array of light detectors 15a-n comprises light detectors 15a-n that detect for example a white light spectrum, plural different white light spectra, red light, orange light, and/or infra-red light. Waveguide 1 may comprise a material or combination of materials that are transparent in the wavelengths of the light 400, for example but not limited to glass, polycarbonate (PC), polymethylmethacrylate (PMMA), acrylates, urethanes, and silicone materials.

The optical system 250 comprises an output section 12 comprising an output reflector 62 that is the transverse anamorphic component 60 and is arranged to reflect the light 400 towards the detection system 240 and direct it along the waveguide 1. In the embodiment of FIGS. 1A-D, the waveguide 1 comprises output section 12 and further comprises a guiding section 10, wherein the output section 12 is integral with the waveguide 1.

The output section 12 further comprises an output face 22 disposed outwardly (i.e. rearwardly) of the rear guide surface 6 and facing the output reflector 62, and the output section 12 is arranged to direct the light 400 towards the detection system 240 through the output face 22. In the embodiment of FIGS. 1A-C, the output face 22 is disposed outwardly of the rear guide surface 6. The output face 22 is a planar surface that extends at an acute angle β to the front and rear guide surfaces 6, 8 of the waveguide 1.

More generally, the output face 22 extends at an acute angle β to the rear guide surface 6 in the case that the output face 22 is on the rear side 6 of the waveguide 1. In the illustrative example of FIG. 1C, β is 30° and is preferably between 20° and 40°. The output section 12 further comprises a separation face 18A extending outwardly (i.e. rearwardly) from the rear guide surface 6 to the output face 22. The output section 12 also comprises a face 18B extending between the output face 22 and the injection reflector 62. Light cone with cone angle ϕ_{T} within the waveguide 1 is directed towards the output reflector 62 with central light ray 401CA being output with maximum luminous intensity. High on-axis efficiency is advantageously achieved.

For output section 12, the detection system 240 is arranged so that light 400 input into the waveguide 1 propagates towards the output face 22 in a second direction 193 to the output reflector 62 (that is the transverse anamorphic component 60) and is input towards the output reflector 62 from a first direction 191 along the waveguide 1 and such that the light 400 is directed in directions that are distributed in the transverse direction 197. In the embodiment of FIGS. 1A-D, the array of light detectors 15a-n are also distributed in the transverse direction 197 so that the light output from the transverse anamorphic component 60 that comprises output reflector 62 is directed in the directions that are distributed in the transverse direction 197.

In the guiding section 10, waveguide 1 comprises: front and rear guide surfaces 8, 6 arranged to guide light from the output reflector 62 along the waveguide 1 in the first direction 191(1) that is the optical axis 199(1) along the waveguide 1 towards the injection reflector 140. The front and rear guide surfaces 8, 6 of the waveguide 1 are planar and parallel such that light rays 401A, 401B guide between the front and rear guide surfaces 8, 6 after reflection from the output reflector 62 and towards the injection reflector 140 in the first direction 191.

Injection reflector 140 is arranged to reflect light to guide along the waveguide 1 in the first direction 191, wherein the injection reflector 140 is a lateral anamorphic component 110 having positive optical power in the lateral direction 195, for example as illustrated in FIG. 1D. The injection reflector 140 is oriented to input light 401 into the waveguide 1 that is input through the front guide surface 8 as for example as illustrated in FIG. 1C.

The injection reflector 140 is an end of the waveguide 1 and comprises the curved end surface 4 of the waveguide 1. A reflective material 67 may be provided on the curved end surface 4 of the waveguide 1. The reflective material 67 may be the same as the reflective material 66. Advantageously cost and complexity of fabrication may be reduced. The injection reflector 140 is oriented to input light 401A, 401B into the waveguide 1 through the front guide surface 8.

The operation of the embodiment of FIGS. 1A-D will now be further described.

It would be desirable to provide an optical detection system that provides a desirable profile of detected illuminance from an illuminated scene. In the present embodiment, each light detector 15a-n of the detection system 240 is arranged to be directed to a respective corresponding detection optical cone 26a-n, wherein each detection optical cone 26a-n is controlled by means of control of the respective light detector 15a-n. For example, central detection optical cone 26C is controlled by control of central light detector 15C and detection optical cone 26R is controlled by control of light detector 15R.

Detection optical cone 26C has an angular pitch α_{L} in the lateral direction 195 and an angular pitch α_{T} in the transverse direction 197. As will be described further hereinbelow, the angular pitches α_{L}, α_{T} are determined by the pitch P_{L}, P_{T} of the respective light detector 15C and the magnification properties of the lateral anamorphic component 110 and transverse anamorphic component 60, respectively.

In the present embodiments the term optical cone, or light cone, refers to an angular cone of light that is provided by one or more light sources by the optical system 250. When projected onto a surface, the optical cones form a structured detection pattern. Such structured detection pattern is illustrated to represent the optical cones of the present embodiments. The term cone may alternatively be described as an optical window (or simply “window”), which is a region of space for which detection is provided, typically in a viewing plane. This is different from a physical window, that is the optical window of the present embodiments is not formed from a material but is a property of a light beam.

Considering FIG. 1A, light rays 401C are directed by the optical system 250 from the detection optical cone 26C and light rays 401R are directed by the optical system 250 from the detection optical cone 26R.

At the input guide surface 8, light rays from the scene are refracted to a light cone within the critical angle of the material in the waveguide 1 and are guided within the waveguide. At the output surface 2, light rays within the light cone within the critical angle of the material in the waveguide 1 are refracted towards the light detectors 15a-n.

Considering FIG. 1B, light detector 15C provides light rays 401CA, 401CB that are directed into the waveguide 1 and from the detection optical cone 26C from different regions on the output reflector 62 and injection reflector 140. Light rays 401CA, 401CB are substantially parallel, and the detection optical cone 26C is provided from the far field, for example at a distance of 25 m from waveguide 1.

FIG. 1B further illustrates that light absorbing arrangement 118 may be provided for surfaces that are not desirably light reflecting, light transmitting or light guiding. Light absorbing arrangement 118 may thus be provided on at least one of edges 24A, 24B and faces 18A, 18B. The light absorbing arrangement 118 may comprise for example a light absorbing coating provided on the respective surfaces, or may be a roughened surface arranged to diffuse incident light onto a coating or an external light absorber. In operation, stray light that is incident onto the light absorbing arrangement 118 may not be reflected back into the waveguide 1. Advantageously the contrast ratio that may be achieved between respective adjacent detection optical cones 26 may be improved.

Considering FIG. 1C, light rays 401CB guides within the output section 12 from the front guide surface 8 such as in the illustrative region 403 and within the guiding section 10, the light rays 401CA, 401CB each guide between the front and rear guide surfaces 8, 6.

Considering FIG. 1D, light rays 401CA, 401CB to light detector 15C that are incident onto the injection reflector 140 are provided with positive optical power in the lateral direction 195 and are subsequently input substantially parallel, in the example of FIG. 1D being out of the plane of the image and towards detection optical cone 26C.

Edges 24A, 24B of the waveguide 1 may be arranged to absorb incident light incident thereon. Advantageously stray light may be reduced. In an alternative embodiment, edges 24A, 24B may be arranged to reflect light by metallic reflection or total internal reflection. Detection of high angles from the waveguide 1 in the lateral direction 195 may advantageously be achieved.

Waveguide 1 of FIGS. 1A-D thus provides detection optical cones 26a-n towards respective light detectors 15a-n by means of optical power in the transverse direction 197 from transverse anamorphic component 60 and optical power in the lateral direction 195 from lateral anamorphic component 110. Output reflector 62 and injection reflector 140 may provide high numerical aperture of collection of light 400 within the waveguide 1 while achieving reduced aberrations in comparison to refractive projection lenses. Thus the maximum cone angular pitch α_{L} that may be achieved in the lateral direction 195 and the maximum cone 26 angular pitch α_{T} that may be achieved in the transverse direction 197 may be increased for desirable aberrational performance. In operation, desirable fidelity of detection optical cones 26a-n may be provided for increased capture angles α_{L}, α_{T}. Advantageously power consumption of the detection apparatus may be reduced and efficiency increased.

The embodiments of FIGS. 1A-D may advantageously be achieved in a compact package that may be conveniently formed by injection moulding or other fabrication techniques at low cost. High efficiency of operation may be achieved and desirable fidelity of detection optical cones 26a-n achieved that may be independently controlled.

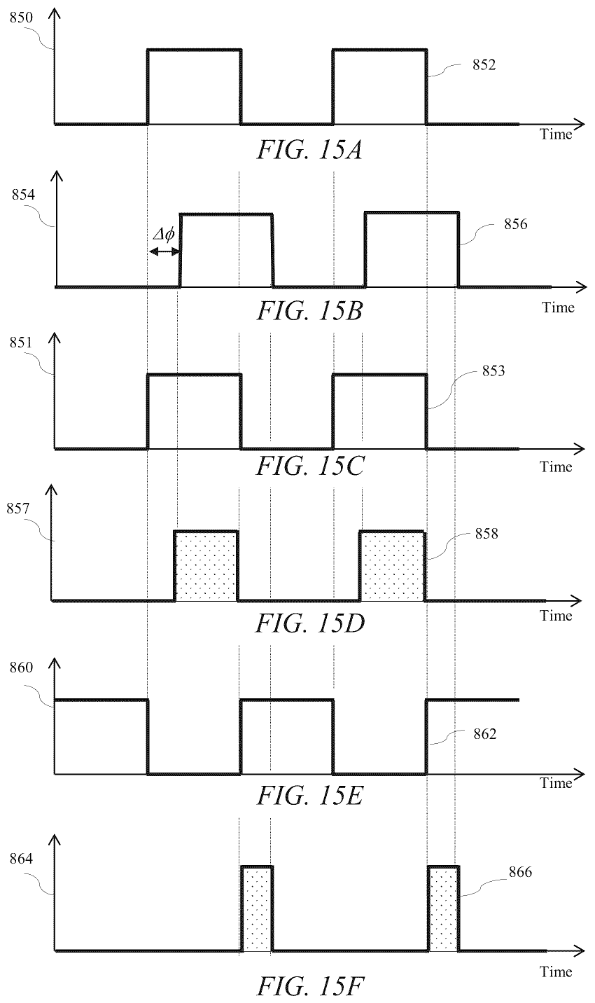

The anamorphic directional detection device 100 may further comprises a capture system 500 arranged to receive data from the light detectors 15. The capture system may comprise an arrangement where the intensity of reflected light is measured on the light detectors 15 and transmitted to a suitable controller. The transmission means may include for example a parallel bus or one or more high speed serial data lines. The light detectors 15 may be a “staring array” of detectors, where the captured image is transferred on an on-chip image store prior to readout. Alternatively the image may be sequentially captured and read out line at a time or pixel at a time. The anamorphic directional detection devices 100 of the present embodiments may be used for detection or measurement of external scenes with high capture efficiency, for example for use in cameras, for example for use in consumer electronic devices, or in LIDAR detectors, for example for use on vehicles. In LIDAR system, the control system 500 may be arranged to provide operation in cooperation with external light sources such as a scanned laser beam or with a short pulsed flood illumination of the illuminated scene. LIDAR detection is described further hereinbelow in FIGS. 15A-F.

FIG. 1E is a schematic diagram illustrating in side view an alternative arrangement of anamorphic directional detection device 100 wherein the output face 22 is arranged on the same side of the waveguide 1 as the front surface 8 of the waveguide. Features of the embodiment of FIG. 1E not discussed in further detail may be assumed to correspond to the features with equivalent reference numerals as discussed above, including any potential variations in the features.

By way of comparison with the embodiment of FIG. 1C, in the alternative embodiment of FIG. 1E, the output face 22 is disposed outwardly (or on the side of) the front guide surface 8. The output face 22 extends at an acute angle β to the front guide surface 8 in the case that the output face 22 is on the front side 8 of the waveguide 1. The total thickness rearwardly of the anamorphic directional detection device 100 is reduced. Further, as will be described with respect to FIGS. 1G-H hereinbelow, the desirable length W of the guiding section 10, that may be determined by the propagation of light ray 401CA within the guiding section 10, may be different to that illustrated in FIG. 1C, achieving an alternative mechanical layout with shorter throw.

In other words, in the alternative embodiment of FIG. 1E the output face 22 is disposed outwardly (i.e. forwardly) of the front guide surface 8 and the separation face 18A extends outwardly (i.e. forwardly) from the front guide surface 8 to the output face 22. In general, where an output section 12 is provided, either integrated with the waveguide 1 or as a separate element, then the output section 12 may be disposed projecting either forwards or backwards so that the output face 22 may be provided forwardly of the front guide surface 8 or rearwardly of the rear guide surface 6. An alternative compact packaging arrangement may advantageously be achieved.

Alternative arrangements of various components of the waveguide 1 will now be described.

FIG. 1F is a schematic diagram illustrating in side view an alternative arrangement comprising plural members 68A, 68B, 69A and the waveguide 1. Features of the embodiment of FIG. 1F not discussed in further detail may be assumed to correspond to the features with equivalent reference numerals as discussed above, including any potential variations in the features.

The transverse anamorphic component 60 further comprises a lens 61 wherein the lens 61 of the transverse anamorphic component 60 is a compound lens 61. Lens 61 may comprise a refractive element 61A. Further lens 61 may comprise a lens 61B comprising the curved output surface 2 of the waveguide 1. Further lens 61 may comprise a curved surface 61C and a material 61D that may be air or a material with different refractive index to the refractive index of the waveguide 1 material. The lenses 61A-D may be arranged to reduce the aberrations of the output reflector 62 of FIGS. 1A-D. The transverse anamorphic component 60 is thus a catadioptric optical element comprising refractive and reflective optical functions. Advantageously the fidelity of the detection optical cones 26a-n may be improved in the transverse direction.

FIG. 1F further illustrates an alternative embodiment wherein the output reflector 62 is arranged on the surface of a member 68A. The surface of the output reflector 62 may advantageously be further protected. FIG. 1F further illustrates an alternative embodiment wherein the injection reflector 140 is arranged on the surface of a member 68B. The surface of the injection reflector 140 may advantageously be further protected. The coatings 66, 67 may be formed on the members 68A, 68B respectively. Higher temperature processing conditions may be achieved than for coating of polymer waveguides 1. Advantageously cost may be reduced and efficiency of operation increased. Gap 69D may be provided between the waveguide 1 end 4 and member 68B, wherein the gap 69D may comprise air or a bonding material such as an adhesive.

In the alternative embodiment of FIG. 1F, the output section 12 is not integral with the waveguide 1. The waveguide 1 has an end that is an output face 2 through which the waveguide 1 is arranged to direct light towards the detection system 240, and the output section 12 is a separate element from the waveguide 1 that further comprises an output face 23 and is arranged to direct light reflected by the output reflector 62 through the output face 23 and into the waveguide 1 through the output face 2 of the waveguide 1. Further, the transverse anamorphic component 60 is disposed outside the waveguide 1, and the waveguide 1 is arranged to direct light 400 towards the transverse anamorphic component 60. In other words, FIG. 1F further illustrates an alternative embodiment wherein the output section 12 and the guide section 10 of the waveguide 1 are formed by separate members 69A, 69B respectively and aligned across gap 69C which may comprise air or a bonding material such as an adhesive. The members 69A, 69B may be formed separately during manufacture, reducing complexity of processing of the waveguide 1 surfaces and advantageously increasing yield.

It may be desirable to increase the area of the circuit board on which the array of light detectors 15a-n is provided.

FIG. 1G is a schematic diagram illustrating in side view an alternative arrangement of anamorphic directional detection device 100 wherein the front guide surface 8 and output face 22 are arranged on a common surface; and FIG. 1H is a schematic diagram illustrating in side view an alternative arrangement of anamorphic directional detection device 100 wherein the rear guide surface 6 and output face 22 are arranged on a common surface. Features of the embodiments of FIGS. 1G-H not discussed in further detail may be assumed to correspond to the features with equivalent reference numerals as discussed above, including any potential variations in the features.

In the alternative embodiment of FIG. 1G, and in comparison to the embodiments hereinabove, the output section 12 further comprises an output face 22 disposed on the front side 8 of the waveguide 1 and facing the output reflector 62, and the output section 12 is arranged to direct the light 401 towards the detection system 240 through the output face 22. In the alternative embodiment of FIG. 1H, the output section 12 further comprises an output face 22 disposed on the rear side 6 of the waveguide 1 and facing the output reflector 62, and the output section 12 is arranged to direct the light 401 to the detection system 240 through the output face 22.

The output face 22 extends parallel to the front guide surface 8 in the case that the output face 22 is on the front side of the waveguide 1 such as illustrated in FIG. 1G or to the rear guide surface 6 in the case that the output face 22 is on the rear side of the waveguide 1 such as illustrated in FIG. 1H.

Further, in the alternative embodiments of FIGS. 1G-H, the output face 22 is coplanar with the front guide surface 8 in the case that the output face 22 is on the front side of the waveguide 1 or with the rear guide surface 6 in the case that the output face 22 is on the rear side of the waveguide 1.

As described with reference to FIG. 1C and FIG. 1E hereinabove, the length W of the guiding section 10 is different between the embodiments of FIGS. 1G-H, advantageously providing alternative packaging arrangements.

Separation face 28 is provided between one of the front and rear guide surfaces 6, 8 and the output reflector 62, and inclined at an angle γ to the respective guide surfaces 6, 8 and may be arranged to minimise the visibility of stray light in the input light cones 26a-n, advantageously achieving increased contrast.

In construction, the circuitry board 158 that for example may be a metal core printed circuit board (MCPCB) may be increased in size. Larger format circuit boards may be provided, advantageously reducing cost.

It may be desirable to provide alternative arrangements of the output face 22.

FIG. 1I is a schematic diagram illustrating in side view an alternative arrangement of anamorphic directional detection device 100 wherein the front guide surface 8 and output face 22 are inclined to each other; and FIG. 1J is a schematic diagram illustrating in side view an alternative arrangement of anamorphic directional detection device 100 wherein the front guide surface 8 and output face 22 are offset from each other. Features of the embodiments of FIGS. 1I-J not discussed in further detail may be assumed to correspond to the features with equivalent reference numerals as discussed above, including any potential variations in the features.

The alternative embodiments of FIGS. 1I-J may achieve optional arrangements for the circuit board 158 and provide alternative mechanical arrangements. The detection properties may further be modified.

It may be desirable to reduce the visibility of stray light.

FIG. 1K is a schematic diagram illustrating in side view an alternative arrangement of anamorphic directional detection device 100 comprising an alternative arrangement of separation faces 28A-C. Features of the embodiment of FIG. 1K not discussed in further detail may be assumed to correspond to the features with equivalent reference numerals as discussed above, including any potential variations in the features.

In the alternative embodiment of FIG. 1K, an alternative arrangement of separation faces 28A-C is provided. The separation faces 28A-C are arranged to minimise the visibility of stray light directed into the waveguide 1. Advantageously improved image contrast is achieved for the detection optical cones 26a-n.

It may be desirable to reduce the difference in the magnification in lateral and transverse directions 195, 197.

FIG. 1L is a schematic diagram illustrating in rear perspective view an alternative arrangement of anamorphic directional detection device 100 wherein the waveguide 1 guiding section 10 is shortened;

FIG. 1M is a schematic diagram illustrating in side view the directional detection device 100 of FIG. 1L; and FIG. 1N is a schematic diagram illustrating in top view the directional detection device 100 of FIG. 1L. Features of the embodiments of FIGS. 1L-N not discussed in further detail may be assumed to correspond to the features with equivalent reference numerals as discussed above, including any potential variations in the features.

In the alternative embodiment of FIGS. 1L-N some of the light guides between front and rear light guide surfaces 8, 6 while other light is guided by one of the front and rear light guide surfaces 8, 6, illustrated by rear light guide surface 6. In comparison to FIG. 1K, in the alternative embodiment of FIGS. 1L-N the separation of the injection reflector 140 from the array of light detectors 15a-n is reduced, so that the angular size of the light cones 26a-n is increased. In operation, the difference between the magnification in the lateral and transverse directions 195, 197 is reduced. The total width of the cones 26a-n in the lateral direction 195 may be increased for a given array of light detectors 15a-n, so that an increased total field of detection is achieved. Further, the separation of the transverse anamorphic component 60 from the array of light detectors 15a-n may be increased, so reducing the cone 26a-n size in the lateral direction 197. Advantageously increased resolution of light cones 26a-n may be achieved in the transverse direction 197.

A vehicle light detector comprising the detection device of FIGS. 1A-D will now be described.

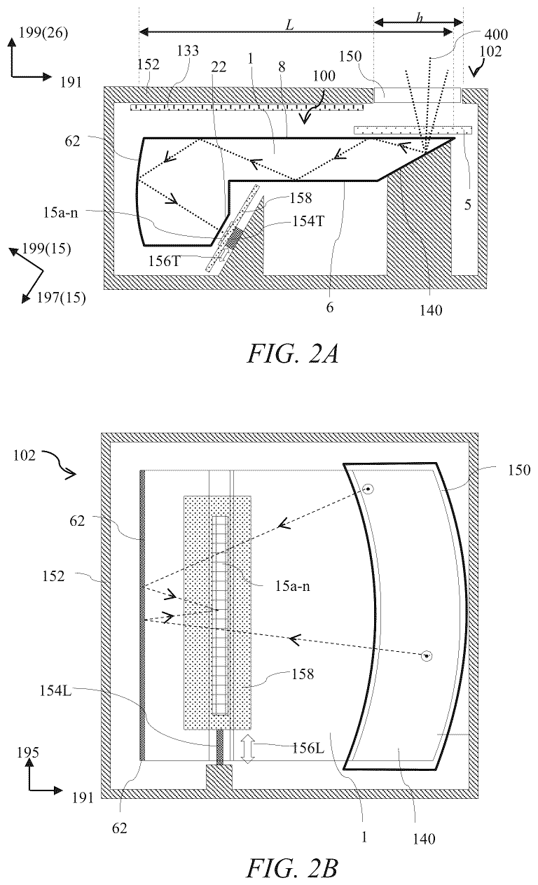

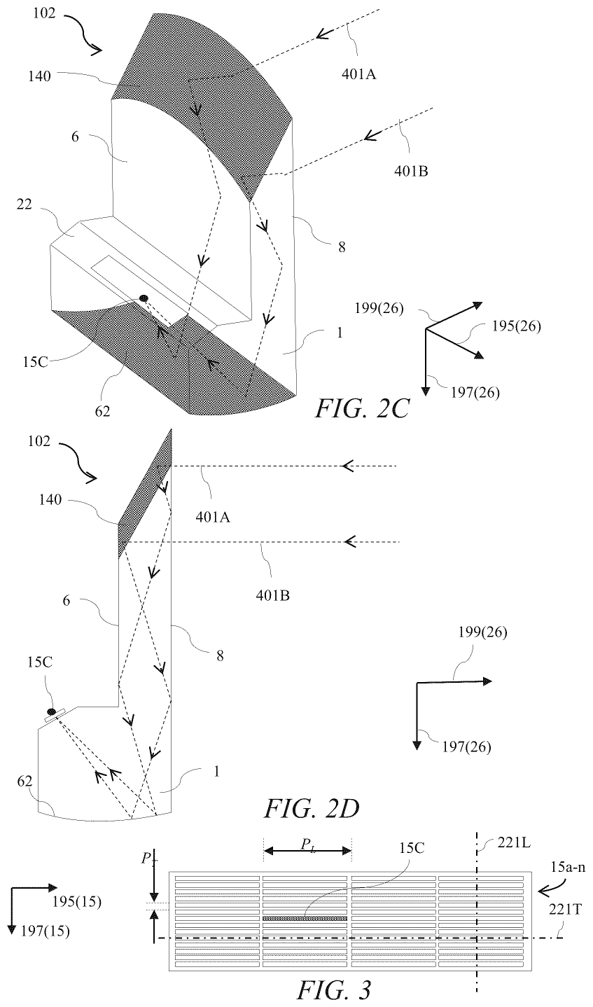

FIG. 2A is a schematic diagram illustrating in side view a vehicle light detector 102 comprising: a housing 152 for fitting to a vehicle 600, and a detection device 100 mounted on the housing; and a transmissive cover extending across the first light guiding surface of the waveguide 1; and FIG. 2B is a schematic diagram illustrating in front view the vehicle light detector 102 of FIG. 2A. Features of the embodiments of FIGS. 2A-B not discussed in further detail may be assumed to correspond to the features with equivalent reference numerals as discussed above, including any potential variations in the features.

FIGS. 2A-B illustrate an alternative embodiment comprising an anamorphic directional detection device 100, being an anamorphic directional detection device 100 for vehicle light detector apparatus 102, wherein the light directed towards the light detectors 15a-n is visible light. A vehicle light detector apparatus 102 comprises: a housing 152 for fitting to a vehicle 600 (not shown); and a transmissive cover 150 extending across the front guide surface 8 of the waveguide 1. Anamorphic directional detection device 100 is mounted on the housing 152 and arranged to direct the input illumination 400 through the transmissive cover 150. The detection device 100 is a backlight for the transmissive cover 150.

In the alternative embodiment of FIG. 2A, the housing 152 is arranged to extend over part of the front guide surface 8 and the transmissive cover 150 is arranged to provide transmission of light input towards the injection reflector 140. In operation, the cover 150 provides high transmission to incident light and further prevents water contacting the waveguide 1. The emitting aperture height h may be small compared to the length L of the waveguide 1. The transmissive cover 150 and housing 152 may typically be curved with desirable shapes to match the shape of the vehicle exterior for example to improve aerodynamic performance and cosmetic appearance. Advantageously desirable aesthetic appearance for the light emitting aperture of the vehicle light detector 102 may be achieved.

The array of light detectors 15a-n may be mounted on a circuit board 158 such as a metal core printed circuit board (MC-PCB), or mounted on a flexible printed circuit which may incorporate one or more heat spreading metal layers. Housing 152 may further be provided for attachment of the LED lightbar 156, and may provide a heat-sink. Advantageously LED junction temperature may be reduced and efficiency and lifetime increased.

Support members, foams and adhesive tapes may be provided to achieve mechanical alignment of the waveguide 1 to the array of light detectors 15a-n. A heater 133 may be provided on the housing 152 or within the housing 152 to provide de-misting and de-icing of the transmissive cover 150. Further, heater elements such as transparent resistive coatings may be formed on the transmissive cover 150 to minimise fogging.

Optional diffuser 5 may be provided to achieve some blurring between adjacent detection optical cones 26a-n. The diffuser 5 may be attached to the cover 150 or may be formed in the surface of the cover 150, for example by injection moulding. Advantageously uniformity of the detection profile may be increased.

It may be desirable to achieve angular control of the nominal direction of the array of detection optical cones 26a-n that is smaller than the size of the individual detection optical cones 26a-n.

FIGS. 2A-B further illustrate an alternative embodiment comprising actuators 154T, 154L arranged to provide translation 156T, 156L respectively of the array of light detectors 15a-n in the transverse direction 197(15) or lateral direction 195 respectively. In operation, the array of light detectors 15a-n are translated so that the nominal optical axis direction 199(26) of the detection optical cones 26a-n is tuned. In an illustrative example, the angular size of the detection optical cone 26C is determined by the size of the light detector 15C and transverse anamorphic component 60 optical power is 10 and the desirable pointing accuracy towards the horizon direction is 0.1°. Such control of pointing accuracy can be achieved by translation 156T in the transverse direction 197. Advantageously the size and power requirements of the actuator 154T may be substantially lower than for actuators that are arranged to steer the vehicle light detector apparatus 102.

FIG. 2C is a schematic diagram illustrating in rear perspective view the light 401A, 401B directed towards a vehicle light detector 102; and FIG. 2D is a schematic diagram illustrating in side view the light 401A, 401B directed towards a vehicle light detector 102. Features of the embodiments of FIGS. 2C-D not discussed in further detail may be assumed to correspond to the features with equivalent reference numerals as discussed above, including any potential variations in the features.

In the alternative embodiments of FIGS. 2C-D, the input illumination illustrated by rays 401A, 401B is collimated input illumination, that is the light rays 401A, 401B are substantially parallel across the injection reflector 140 for directing towards a single light detector 15C. In practice, some non-parallel behaviour is provided by aberrations of the optical system 250 although desirably the aberrations are minimised.

Such an arrangement of collimated input rays 401A, 410B advantageously achieves increased fidelity of detection optical cones 26a-n when the detection optical cones 26a-n are in the far field of the vehicle light detector 102, for example illuminating a scene 450 as described elsewhere herein.

Arrangements of light detector array 15a-n will now be described.

FIG. 3 is a schematic diagram illustrating in front view a light detector array 15a-n for the anamorphic directional detection device 100 of FIG. 1A. Features of the embodiment of FIG. 3 not discussed in further detail may be assumed to correspond to the features with equivalent reference numerals as discussed above, including any potential variations in the features.

FIG. 3 illustrates an arrangement of light detectors 15a-n which have pitches P_{L}, P_{T} in the lateral and transverse directions 195, 197. The row 221T of light detectors 15 provides a row of detection optical cones 26 when imaged by the lateral anamorphic component 110, and column 221L of light sources provides a column of detection optical cones 26 when imaged by the transverse anamorphic component 60 as described hereinabove.

The angular magnification M_{L}, M_{T} of the lateral and transverse anamorphic optical elements 110, 60 is proportional to the respective optical power K_{L}, K_{T} of said elements 60, 110. In the alternative embodiment of FIG. 3, the array of light detectors 15a-n may be arranged with pitches P_{L}, P_{T} in the lateral and transverse directions 195, 197 with a ratio that is the same as the inverse of the ratio of optical powers K_{L}, K_{T} of the lateral and transverse anamorphic optical elements 110, 60. In operation the detection optical cones 26 have the same angular extent in the lateral and transverse directions 195, 197.

Arrangements of transverse anamorphic component 60 comprising lenses will now be described.

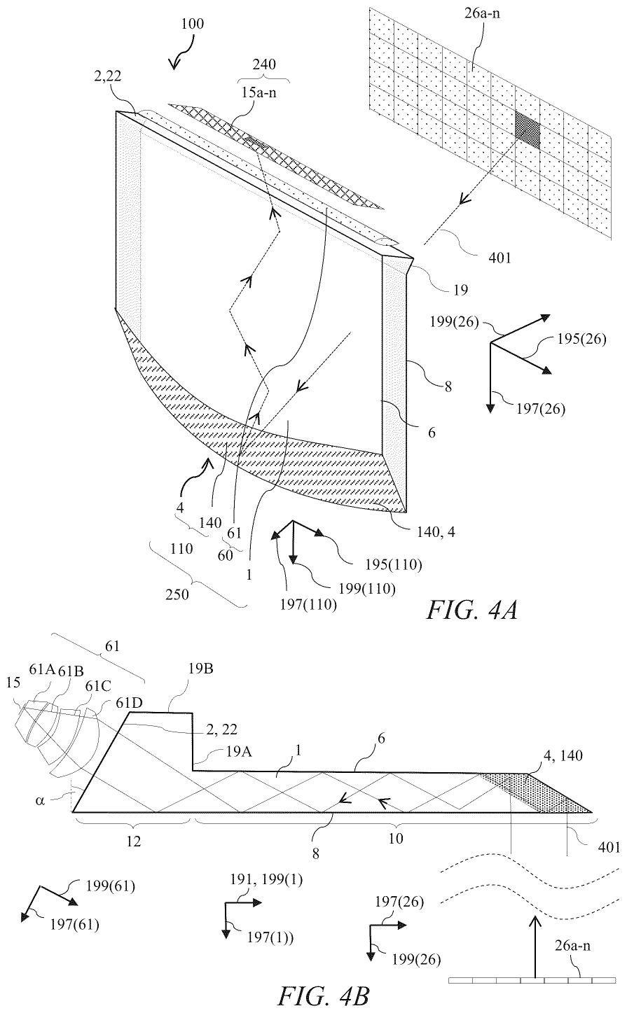

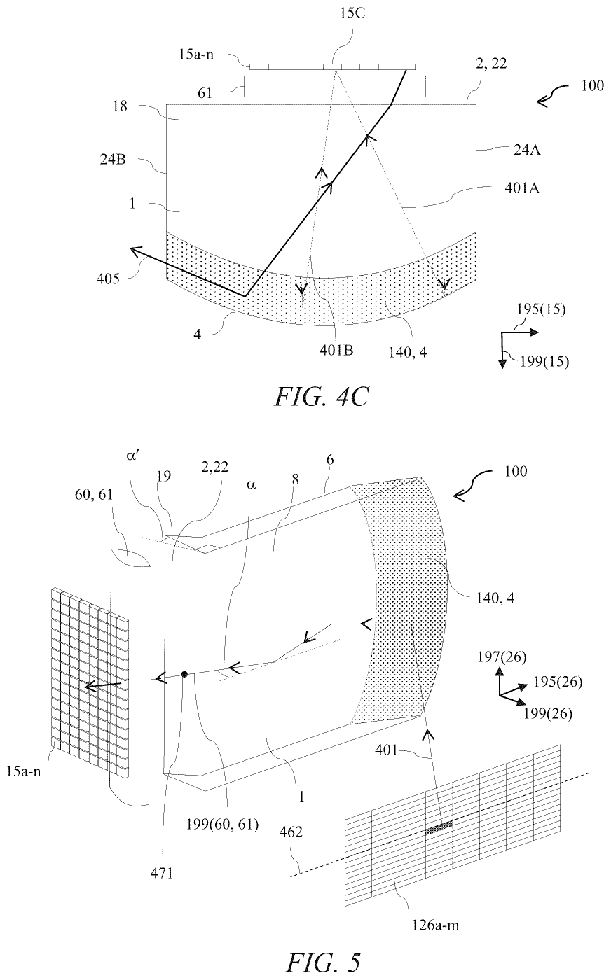

FIG. 4A is a schematic diagram illustrating in rear perspective view an anamorphic directional detection device 100 comprising a waveguide 1 comprising a curved reflective lateral anamorphic component 110 that is a reflection extractor 140 and is an end 4 of the waveguide 1, and a transverse anamorphic component 60 that is a lens 61; FIG. 4B is a schematic diagram illustrating in side view a waveguide 1 comprising a curved reflective lateral anamorphic component 110 that is a reflection extractor 140 and is an end 4 of the waveguide 1, and a transverse anamorphic component 60 that comprises a compound lens 61A-D; and FIG. 4C is a schematic diagram illustrating in front view the operation of the waveguide 1 of FIGS. 4A-B. Features of the embodiments of FIGS. 4A-C not discussed in further detail may be assumed to correspond to the features with equivalent reference numerals as discussed above, including any potential variations in the features.

By way of comparison with FIG. 1A, in the alternative embodiment of FIG. 4A, the waveguide 1 has an end 2 that is an output face 22 through which the waveguide 1 is arranged to direct light towards the detection system 240. The transverse anamorphic component 60 is disposed outside the waveguide 1, and the waveguide 1 is arranged to direct light 400 towards the transverse anamorphic component 60 through the output face 22 that is an end 2 of the waveguide 1.

Further, the transverse anamorphic component 60 comprises a lens 61. As illustrated in the alternative embodiment of FIG. 4B, the lens 61 may be a compound lens comprising lens elements 61A-D of FIG. 4B. Advantageously aberrational performance may be improved in the transverse direction 197 and the detection optical cones 26a-n may be provided with increased fidelity. Sharpness of the edges of the detection optical cones 26a-n may be increased and contrast between illuminated and non-illuminated detection optical cones 26 increased.

FIG. 4B further illustrates that the output section 12 comprises non-output surfaces 19A, 19B such that light 401 is output from the guiding section 10 at an angle and propagates in the first direction 191 along the waveguide 1.

Light is output through the output face 22 that is an end 2 of the waveguide 1 whereas in FIG. 1A the output reflector 62 comprises an end 2 of the waveguide 1. Advantageously light losses from the reflectivity of the output reflector 62 in FIG. 1A are not present.

The alternative embodiment of FIG. 4A illustrates a single separation face 19 extending between the front guide surface 8 and the output face 22 whereas FIG. 4B further illustrates a first separation face 19B extending outwardly (i.e. rearwardly) from the rear guide surface 6 to a second separation face 19A extending between the first separation face 19B and the output face 22. The arrangement of separation faces 19 may be provided to minimize stray light, advantageously increasing contrast of detection optical cones 26a-n.

It may be desirable to provide a different orientation of the anamorphic directional detection device 100.

FIG. 5 is a schematic diagram illustrating in front perspective view a waveguide 1 of FIG. 4A with an alternative alignment of detection optical cones 26a-n. Features of the embodiment of FIG. 5 not discussed in further detail may be assumed to correspond to the features with equivalent reference numerals as discussed above, including any potential variations in the features.

In the alternative embodiments of FIGS. 4A-C and FIG. 5, the direction of the optical axis 199 through the transverse anamorphic component 60 is inclined at an acute angle α with respect to the front and rear guide surfaces 8, 6 of the waveguide 1 and the output face 22 is inclined at an acute angle α′ with respect to the front and rear guide surfaces 8, 6 of the waveguide 1. The acute angles α, α′ may be the same and in operation, light rays that are parallel to the optical axis 199(60) are passed through the output face 22, for example at illustrative point 471, without deviating due to refraction. Advantageously reduced aberrations are achieved for on-axis light. Further, the light cones are arranged to guide along the waveguide at angles different to directions along the waveguide in the transverse direction 197(1). The light cones 26a-n may be provided without a set of light cones that have been reflected in the transverse direction, advantageously reducing the visibility of stray light and fidelity of the detected light rays.

In comparison to the embodiment of FIG. 4A, the injection reflector 140 is arranged with a portrait orientation which may be considered more aesthetically desirable. Further the aberration performance of the detection optical cones 26a-n may be different between the transverse and lateral directions 197, 195. Aberrations along the horizon 462 may be controlled differently in comparison to the embodiment of FIG. 1A by compound lens 61A-D. Advantageously a sharper transition may be achieved.

Alternative detection systems 240 will now be described.

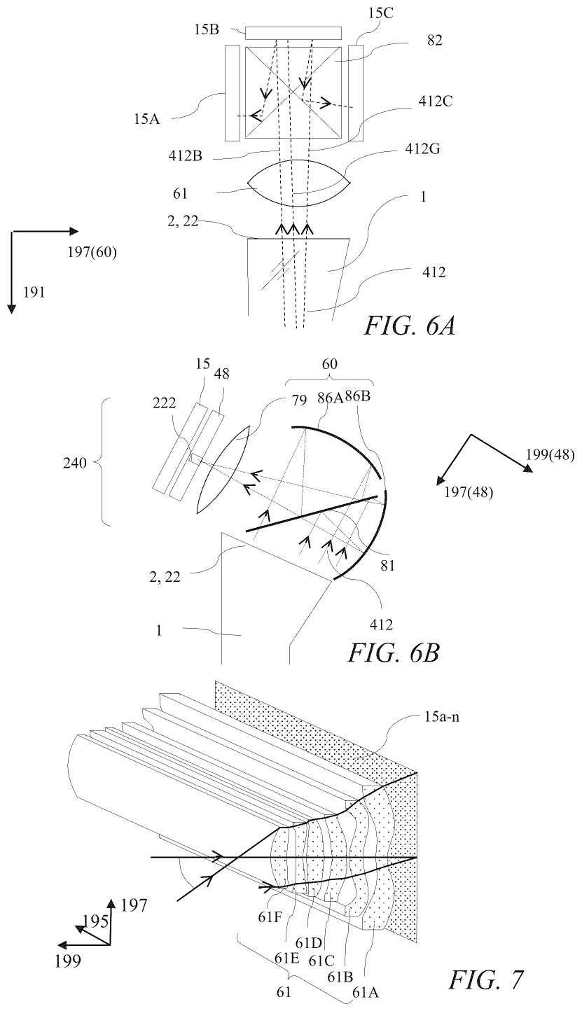

FIG. 6A is a schematic diagram illustrating in side view a detection system 240 for use in the anamorphic directional detection device 100 of FIG. 1A or FIG. 4A comprising separate wavelength light detector arrays 15A, 15B, 15C and a light splitter 82. Features of the embodiment of FIG. 6A not discussed in further detail may be assumed to correspond to the features with equivalent reference numerals as discussed above, including any potential variations in the features.

The detection system 240 comprises plural arrays of light detectors 15Aa-m, 15Ba-n, 15Ca-p and a light splitter 82 arranged to split light of different wavelengths to each of the arrays of light detectors 15a-n to form the output light of the detection system 240.

The embodiments described hereinbefore have comprised light generation element 230 and a wavelength conversion element 232 arranged in a well 234. It may be desirable to provide detection from multiple different light detector arrays.

If the directional detection device 100 is a camera for operation in visible light then the light detector arrays 15A, 15B, 15C may comprise red, green and blue detector arrays 15R, 15G, 15B respectively. The alternative embodiment of FIG. 6A illustrates that the detection system 240 may comprise red, green and blue light detector arrays 15Ra-m, 15Ga-n, 15Ba-p and a colour combining prism arranged to direct light rays 412R, 412G, 412B towards the transverse anamorphic component 60. Such an arrangement may be used to provide high resolution colour control of optical cones 26Ra-m, 26Ga-n, 26Ba-p. Such coloured detection optical cones 26Ra-m, 26Ga-n, 26Ba-p may achieve controlled detection of scenes with appropriate coloured light. Advantageously increased information may be provided to drivers for example to provide coloured detection of particular hazards or safe driving directions.

The light detector arrays may comprise monolithic wafers or may comprise separate elements provided by pick-and-place of LED packages or mass transfer technologies.

In alternative embodiments, for example for use in multi-wavelength detector systems, the light detector arrays 15 may be provided with different wavelengths such as infra-red wavelengths as will be described further hereinbelow with respect to FIGS. 15A-F for example.

FIG. 6B is a schematic diagram illustrating in side view a detection system 240 for use in the anamorphic directional detection device of FIG. 4A comprising a birdbath folded arrangement. Features of the embodiment of FIG. 6B not discussed in further detail may be assumed to correspond to the features with equivalent reference numerals as discussed above, including any potential variations in the features.

In the present embodiments, the anamorphic directional detection device 100 may further comprise multiple detector arrays 48 that may be arranged between an array of light sources and the transverse anamorphic component 60. The detection optical cones 26a-n may be provided by imaging of pixels 222 of the multiple detector arrays 48. Advantageously increased resolution of detection optical cones 26a-n may be achieved. In other embodiments, the array of light detectors 15a-n may comprise the pixels 222 of multiple detector arrays.

In the alternative embodiment of FIG. 6B, the multiple detector arrays 48 illuminates a catadioptric detection system 240 comprising output lens 79, curved mirror 86A and partially reflective mirror 81 such that rays 412 are directed towards the output side 2 of the waveguide 1. Advantageously chromatic aberrations in the transverse direction 197 may be reduced. The partially reflective mirror 81 may be a polarising beam splitter or may be a thin metallised layer for example.

Additionally or alternatively curved mirror 86B may be provided to increase efficiency of operation.

FIG. 7 is a schematic diagram illustrating in perspective front view an alternative arrangement of an output focussing lens 61. Features of the embodiment of FIG. 7 not discussed in further detail may be assumed to correspond to the features with equivalent reference numerals as discussed above, including any potential variations in the features.

Light detector array 15a-n is aligned to the lens 61 of the transverse anamorphic component 60 that is a compound lens comprising lenses 61A-F. Some of the lenses 61A-F may comprise surfaces that have a constant radius and some may comprise variable radius surfaces such that in combination aberration correction is advantageously improved. Advantageously improved resolution of detection optical cones 26a-n may be achieved.

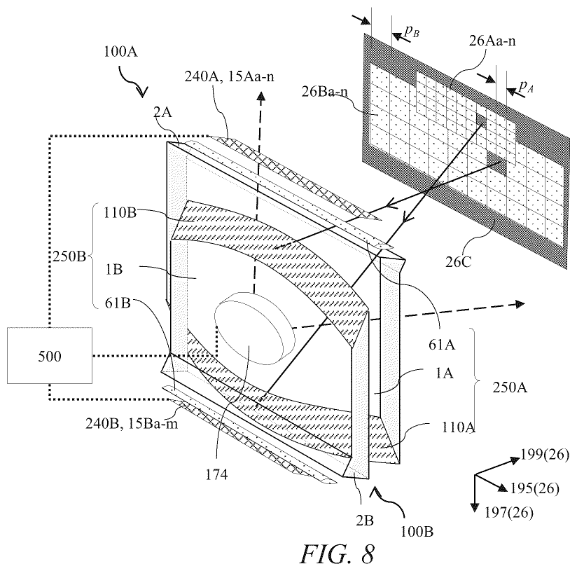

FIG. 8 is a schematic diagram illustrating in rear perspective view a stack of waveguides 1 arranged to provide complementary detection. Features of the embodiment of FIG. 8 not discussed in further detail may be assumed to correspond to the features with equivalent reference numerals as discussed above, including any potential variations in the features.

In the alternative embodiment of FIG. 8, the anamorphic directional detection device 100 comprises plural detection systems 240A, 240B and plural optical systems 250A, 250B, wherein each optical system 250A, 250B is arranged to direct light towards a respective detection system 240A, 240B, and the waveguides 1A, 1B of each optical system 250A, 250B are stacked to provide detection in a common direction 199(26).

Further, in the alternative embodiment of FIG. 8, each detection system 240A, 240B and the corresponding optical system 250A, 250B are arranged to provide detection from detection optical cones 26Aa-n, 26Ba-m having pitches p_{A}, p_{B} that are different in at least one of the transverse and lateral directions 197, 195.

In operation, increased illuminance and resolution of light control may be achieved in at least one region of overlap of detection optical cones 26Aa-n, 26Ba-m. Improved control of overall detection profile may be achieved. The spectral input of the detection systems 240A, 240B may be different, for example one detection system 240A may provide visible detection and the other may provide infra-red detection.

The alternative embodiment of FIG. 8 illustrates the type of directional detection device 100 of FIG. 4A for example. In other embodiments, one or both of the directional detection devices 100A, 100B may comprise the type of directional detection device 100 of FIG. 1A or described elsewhere herein for example.

The alternative embodiment of FIG. 8 further illustrates an embodiment of a directional light detection device 100 being a light detection and ranging (LIDAR) apparatus, wherein the directional light detection device 100 further comprises a light source 174 arranged to output infra-red light for illumination of the remote scene; the light detectors 15a-n are arranged to detect infra-red light; and the directional light detection device further comprises a control system 500 that is arranged to detect geometry of the remote scene from the light detected by the light detectors, as described in FIGS. 15A-F hereinbelow. The light source 174 is arranged to direct light through the directional light detection device 100, advantageously achieving a compact arrangement. Alternatively, the light source 174 may be arranged in an alternative location to the directional light detection device 100.

It may be desirable to provide an output aperture with alternative appearance.

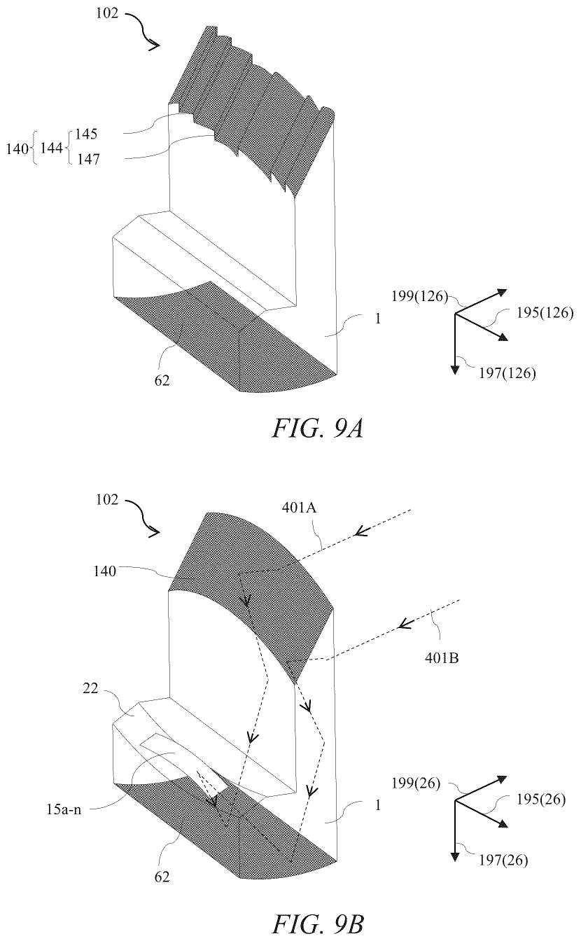

FIG. 9A is a schematic diagram illustrating in rear perspective view a waveguide 1 for an anamorphic directional detection device 100 and comprising a Fresnel reflector 140. Features of the embodiment of FIG. 9A not discussed in further detail may be assumed to correspond to the features with equivalent reference numerals as discussed above, including any potential variations in the features.

By way of comparison with FIG. 1A, the alternative embodiment of FIG. 9A provides an input reflector 140 that is a Fresnel mirror 144 comprising input facets 145 and draft facets 147. The input reflector 140 has an input aperture shape that is more rectangular than illustrated hereinabove that may advantageously achieve a more desirable cosmetic appearance.

It may be desirable to reduce detection optical cone 26 blur at higher lateral field angles.

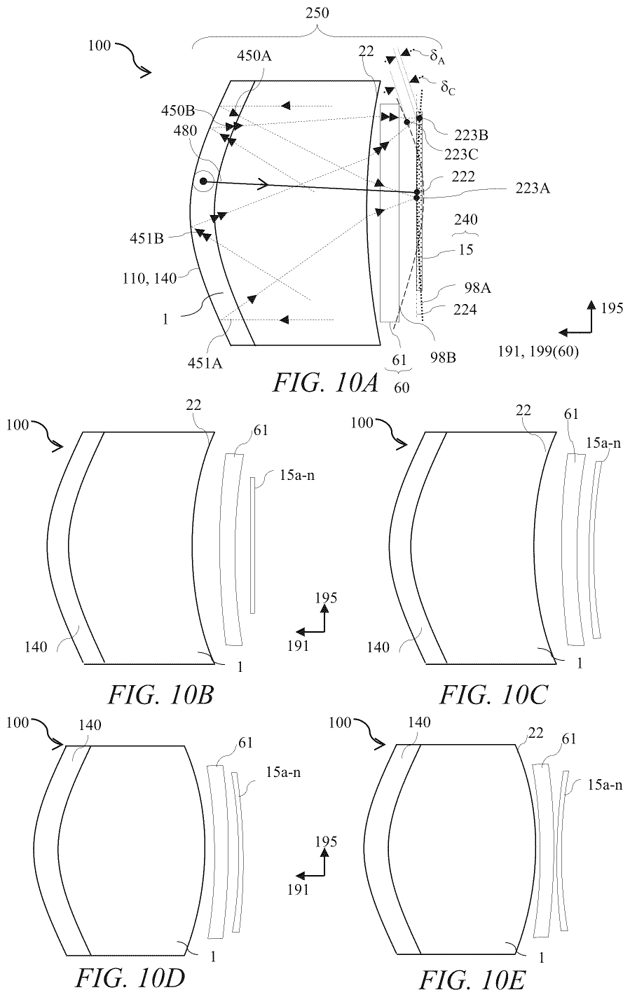

FIG. 9B is a schematic diagram illustrating in rear perspective view an anamorphic directional detection device 100 comprising a curved output face 22 and a curved light detector array 15a-n; and FIG. 10A is a schematic diagram illustrating in front view an anamorphic directional detection device 100 wherein the output face 22 of the injection waveguide 1 has curvature in the lateral direction 195. Features of the embodiments of FIG. 9B and FIG. 10A not discussed in further detail may be assumed to correspond to the features with equivalent reference numerals as discussed above, including any potential variations in the features.

In comparison to the embodiments of FIG. 1A and FIG. 4A, in the alternative embodiments of FIG. 9B and FIG. 10A respectively, at least one of an output face 22 of the waveguide 1, the transverse anamorphic component 60 and the array of light detectors 15a-n has a curvature in the lateral direction 195 that compensates for field curvature of the injection reflector 140.

The operation of the curved surfaces of FIG. 9B and FIG. 10A will now be described further with reference to FIG. 10A, however such arrangements may alternatively be provided for the embodiment of FIG. 9B.

By way of comparison with the present embodiment, FIG. 4A illustrates an output face 22, transverse anamorphic component 60 and light detector array 15a-n with light detector array 15a-n lying on detection face 224 that has no curvature in the lateral direction 195.

In practice, aberrations of the lateral anamorphic component 110 have Petzval field curvature with an illustrative curved field surface 98B shown in FIG. 10A that is separated by distance 8 from the detection face 224 that varies. Light detectors 15 on detection face 224 that are more widely separated in the direction 191 from the field surface 98B have reduced modulation transfer function (MTF), appearing more blurry. Considering the field surface 98B then light detectors 15 that are off-axis in the lateral direction 195 may be perceived with increased detection optical cone 26 blur in comparison to light detectors 15 that are on-axis.

By way of comparison with FIG. 1A, the alternative embodiment of FIG. 22D provides an extraction reflector 140 that is a Fresnel mirror 144 comprising extraction facets 145 and draft facets 147. The extraction reflector has an output shape that is more rectangular than illustrated hereinabove that may advantageously achieve a more desirable cosmetic appearance.

It would be desirable to provide light detectors 15 of the light detector array 15a-n that are on a field surface 98A that is close to the detection face 224 of the detection system 240 across the light detector array 15a-n in the lateral direction 195.

Considering the embodiment of FIG. 10A, the curved output face 22 of the injection waveguide 1 provides a modified field surface 98A. The curved output face 22 may be an output face 22 as illustrated in FIG. 4A for example or may be the output face 22 as illustrated in FIG. 1A for example.

In operation, light ray 480 is an illustrative light ray for output light towards light detector 15 on the transverse anamorphic component 60 that is directed towards a respective detection optical cone 26. Indicative light rays 450A, 451A, 450B, 451B illustrate light rays that would propagate from the detection optical cone 26 towards the light detector array 15a-n if a light source were to be arranged at a location corresponding to the detection optical cone 26. Indicative light rays 450A, 451A form indicative image point 223A and indicative light rays 450B, 451B form indicative image point 223B where indicative image points 223A, 223B lie in the surface 98A.

Considering the point of best focus 223B, the separation δ_{AB} of the surface 98A from the plane of the light detectors 15 of the light detector array 15a-n is reduced across the field of view in comparison to the separation δ_{B} provided by surface 98B that would provide a point of best focus 223C.

In the alternative embodiment of FIG. 10A, the output face 22 of the injection waveguide 1 thus has a curvature in the lateral direction 195 that compensates for Petzval field curvature of the lateral anamorphic component 110. Thus the desirable field surface 98A provided by FIG. 10B is more closely aligned to the pixel plane 224 of the light detector array 15a-n. MTF for off-axis field points is increased and advantageously detection optical cone 26 blur is reduced.

Alternative embodiments to reduce field curvature will now be described.

FIG. 10B is a schematic diagram illustrating in front view an anamorphic directional detection device 100 wherein the output face 22 of the injection waveguide 1 has curvature in the lateral direction 195 and the transverse anamorphic component 60 has curvature in the lateral direction 195; FIG. 10C is a schematic diagram illustrating in front view an anamorphic directional detection device 100 wherein the output face 22 of the injection waveguide 1 has curvature in the lateral direction 195, the transverse anamorphic component 60 has curvature in the lateral direction 195, and the light detector array 15a-n has curvature in the lateral direction 195; FIG. 10D is a schematic diagram illustrating in front view an anamorphic directional detection device 100 wherein the output face 22 of the injection waveguide 1 has curvature in the lateral direction 195, the transverse anamorphic component 60 has curvature in the lateral direction 195 and the light detector array 15a-n has curvature in the lateral direction 195, where the direction of curvature of each of the output face 22, the transverse anamorphic component 60 and the light detector array 15a-n is opposite to that of FIG. 10C; and FIG. 10E is a schematic diagram illustrating in front view an anamorphic directional detection device 100 wherein the output face 22 of the injection waveguide 1 has curvature in the lateral direction 195, the transverse anamorphic component 60 has curvature in the lateral direction 195, and the light detector array 15a-n has curvature in the lateral direction 195, where the direction of curvature of each of the output face 22 and the transverse anamorphic component is the opposite to that of FIG. 10C, and the direction of curvature of the light detector array 15a-n is the same as that of FIG. 10C. Features of the embodiments of FIGS. 10B-E not discussed in further detail may be assumed to correspond to the features with equivalent reference numerals as discussed above, including any potential variations in the features.

The alternative embodiments of FIGS. 10B-E are examples illustrating the case that at least one of the output face 22 of the injection waveguide 1, the transverse anamorphic component 60 and the light detector array 15a-n has a curvature in the lateral direction 195 in a manner that compensates for Petzval field curvature of the lateral anamorphic component 110. The directions of curvature of respective elements 2, 60, 48 may be modified to achieve optimised detection optical cone 26 performance so that the MTF for off-axis field points is further increased and advantageously detection optical cone 26 blur is reduced.

In comparison to non-anamorphic components, the curvature may be arranged about only one axis. In particular, the light detector array 15a-n may comprise a silicon or glass backplane. Such backplanes are not typically suitable for curvature about two axes. However in the present embodiments, single axis curvature may achieve desirable correction for field curvature. Advantageously the cost of achieving a suitably curved light detector array 15a-n may be reduced.

Illustrative arrangements of vehicle light detectors 102 will now be described.

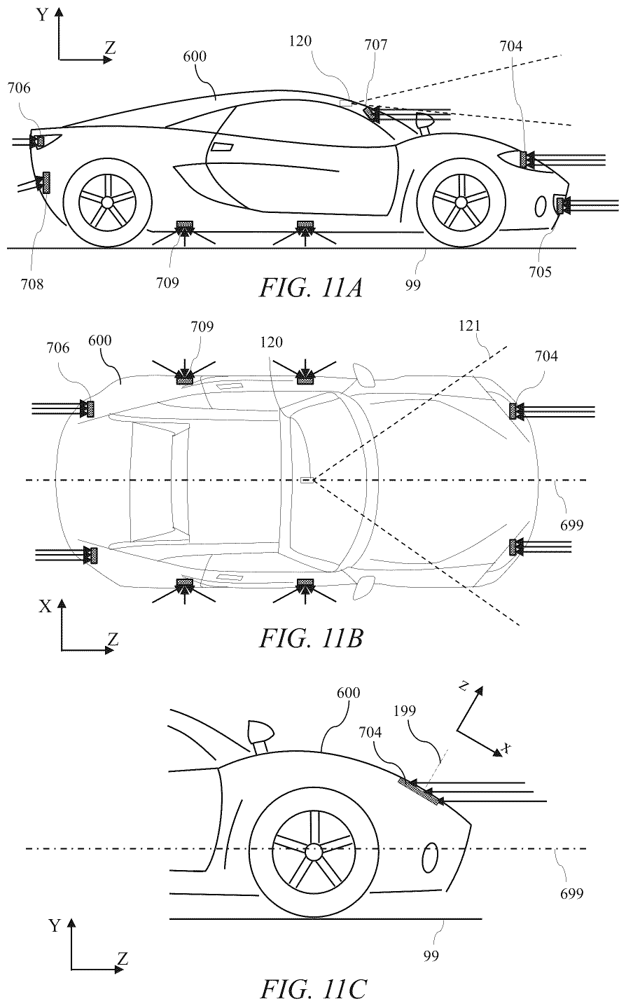

FIG. 11A is a schematic diagram illustrating in side view a vehicle comprising vehicle light detectors 102 of the present embodiments; FIG. 11B is a schematic diagram illustrating in top view a vehicle comprising vehicle light detectors 102 of the present embodiments; and FIG. 11C is a schematic diagram illustrating in side view part of a vehicle comprising vehicle light detectors 102 that are mounted with tilted orientations. Features of the embodiments of FIGS. 11A-C not discussed in further detail may be assumed to correspond to the features with equivalent reference numerals as discussed above, including any potential variations in the features.

The vehicle light detectors 102 of the present embodiments have thin profile and may provide reduction of detection device volume in comparison to known detection structures. The vehicle light detectors 102 may be arranged in various locations across the vehicle, including next to or over vehicle illumination devices such as headlights, fog lights, and indicators.

In another embodiment the vehicle light detector 707 may be provided next to or on the windscreen of the vehicle 600. Infra-red sources can be used to illuminate the illuminated scene with illumination that may be scanned. Advantageously the vehicle light detector 102 can achieve enhanced signal-to-noise ratio for the camera 120 used to monitor the road scene.

The present embodiments advantageously achieve significant reduction of volume of vehicle light detectors 102. It may be desirable to further reduce the volume of the vehicle that is occupied and to modify cosmetic appearance.

FIG. 11C is a schematic diagram illustrating in side view part of a vehicle 600 comprising vehicle light detectors 102 and headlights 704 that are mounted with tilted orientations.

In the present figures, the coordinate system denoted by small letters x, y, z is in the frame of the anamorphic directional detection device 100, and the coordinate frame denoted by capital letters X, Y, Z is in the frame of the vehicle 600. The coordinate frame x, y, z is not typically aligned to the coordinate frame X, Y, Z, that is, the detection device 100 is typically rotated in the vehicle 600 as illustrated for example in FIG. 11C. The lateral direction in the present embodiments is the direction in which the detection optical cones 26 are controlled, and thus the x-axis direction in FIG. 1A.

Vehicle light detectors 102 may have features 12, 312 with profile shapes that are arranged to provide nominal detection cone angle directions in the lateral direction that are offset from the normal 199 to the anamorphic detection device 100. The headlight 704 and/or vehicle light detectors 102 may be arranged with orientations that are similar to body panel orientations. Advantageously volume of the vehicle light detectors 102 may be reduced.

Directional detection devices 200 that provide one-dimensional arrays of detection optical cones 26a-n will now be described.

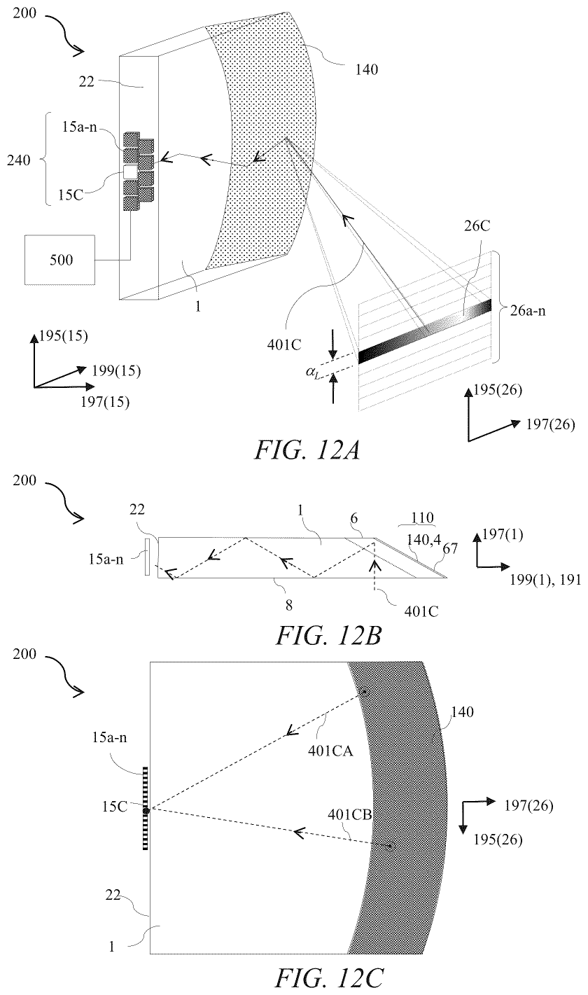

FIG. 12A is a schematic diagram illustrating in front perspective view a directional detection device 200 comprising a waveguide 1 with a curved reflective lateral anamorphic component 60 arranged to provide a one-dimensional array of detection optical cones 26a-n; FIG. 12B is a schematic diagram illustrating in side view the directional detection device 200 of FIG. 12A; and FIG. 12C is a schematic diagram illustrating in front view the directional detection device 200 of FIG. 12A. Features of the embodiments of FIGS. 12A-C not discussed in further detail may be assumed to correspond to the features with equivalent reference numerals as discussed above, including any potential variations in the features.

In the embodiments of FIGS. 12A-C a directional detection device 200 comprises an array of light detectors 15a-n distributed in a lateral direction 195; and a waveguide 1 arranged to direct light towards the array of light detectors 15a-n. The light detectors 15a-n may be light emitting diodes.

The waveguide 1 comprises front and rear guide surfaces 8, 6 arranged to guide light from the light detectors 15a-n along the waveguide 1. Injection reflector 140 is arranged to reflect light that has been guided along the waveguide 1, wherein the injection reflector 140 has positive optical power in the lateral direction 195 and is oriented to inject light out of the waveguide 1 through at least one of the guide surfaces 8, 6 as input illumination. The input detection aperture provided by the injection reflector 140 is reduced in height, advantageously improving the aesthetic appearance in a vehicle application. The region of the waveguide 1 that is not near the injection reflector 140 may be hidden, in a similar manner to that described in FIG. 2A for example.

In comparison to the embodiments of FIG. 1A and FIG. 4A hereinabove, in the alternative embodiment of FIGS. 12A-C the transverse anamorphic component 60 is omitted. Advantageously cost and complexity of the waveguide 1 is reduced.

Detection optical cones 26a-n are distributed across the lateral direction 195 wherein the optical window 26C has an angular pitch α_{L} and extended in the transverse direction 197. Advantageously cost and complexity of the control system 500 is reduced.

The front and rear guide surfaces 8, 6 of the waveguide 1 are planar and parallel. The waveguide 1 has no optical power in a transverse direction 197 that is perpendicular to the lateral direction 195 and the injection reflector 140 is an end 4 of the waveguide 1.

In the embodiment of FIGS. 12A-C, the array of light detectors 15a-n are also distributed in the transverse direction 197.

The waveguide 1 has an end 2 that is an output face 22 through which the waveguide 1 is arranged to direct light towards the detection system 240 and the injection reflector 140 is oriented to inject light into the waveguide 1 through one of the front guide and rear guide surfaces 8 as output illumination.

The array of light detectors 15a-n may comprise light detectors 15a-n with different spectral detection bandwidths. The different spectral outputs include: a white light spectrum, plural different white light spectra, red light, orange light, and/or infra-red light.

At least one of an output face 22 of the waveguide 1, and the array of light detectors 15a-n has a curvature in the lateral direction 195 that compensates for field curvature of the injection reflector 140 as described elsewhere herein with respect to FIGS. 10A-F.

Folded arrangements of directional detection device 200 will now be described.

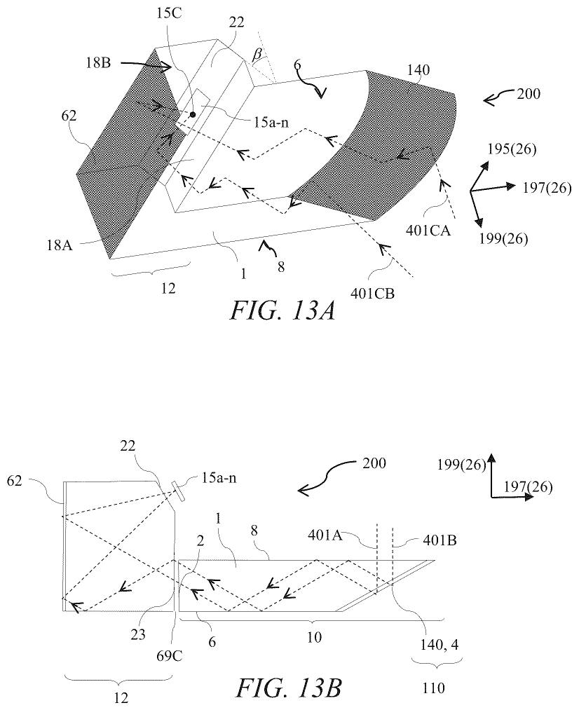

FIG. 13A is a schematic diagram illustrating in rear perspective view a directional detection device 200 comprising a waveguide 1 with a planar reflective end 62 and a lateral anamorphic component 60 comprising a curved injection reflector 140. Features of the embodiment of FIG. 13A not discussed in further detail may be assumed to correspond to the features with equivalent reference numerals as discussed above, including any potential variations in the features.

The directional detection device 200 further comprises an output section 12 comprising an output reflector 62 that is arranged to reflect the light towards the detection system 240 and direct it along the waveguide 1.

The output section 12 further comprises an output face 22 disposed outwardly (i.e. rearwardly) of the rear guide surface 6 and facing the output reflector 62, wherein the output section 12 is arranged to direct light towards the detection system 240 through the output face 22.

The output face 22 is disposed outwardly of one of the front or rear guide surfaces 8, 6. More generally, the arrangements of the alternative embodiments disclosed hereinabove may be provided wherein the output reflector 62 is provided with no optical power, that it is provided by one or more planar surfaces. The complexity of tooling of the reflective end 62 may advantageously be reduced.

The output section 12 further comprises an output face 22 disposed on a front or rear side of the waveguide 1 and facing the output reflector 62, wherein the output section 12 is arranged to direct light 401 towards the detection system 240 through the output face 22.

The output face 22 extends at an acute angle β to the front guide surface 8 in the case that the output face 22 is on the front side of the waveguide 1 or to the rear guide surface 6 in the case that the output face 22 is on the rear side of the waveguide 1.

In the embodiment of FIG. 13A, the output section 12 is integral with the waveguide 1. The waveguide 1 may be conveniently manufactured as described elsewhere herein in one part advantageously with reduced cost and complexity.

FIG. 13B is a schematic diagram illustrating in side view a directional detection device 200 comprising a waveguide 1 with an output section 12 comprising planar reflective end 62 and a waveguide 1 comprising a lateral anamorphic component 110 comprising a curved injection reflector 140. Features of the embodiment of FIG. 13B not discussed in further detail may be assumed to correspond to the features with equivalent reference numerals as discussed above, including any potential variations in the features.

In the alternative embodiment of FIG. 13B, the waveguide 1 has an end 2 that is an output face 22 through which the waveguide 1 is arranged to direct light towards the detection system 240, and the output section 12 is a separate element from the waveguide 1 that further comprises a separation face 23 and is arranged to direct light reflected by the output reflector 62 through the output face 23 and into the waveguide 1 through the output face 2 of the waveguide 1. The output section 12 further comprises a separation face 23 extending outwardly (i.e. rearwardly) from the rear guide surface 6 to the output face 22. Advantageously the cost and complexity of fabrication of the directional detection device 200 may be reduced.

Arrangements of light detectors 15 will now be described.

The light detector 15 may comprise an image collection device such as a CCD or CMOS imager, and may comprise colour selective light detector elements, such as red, green and blue imager pixels that are spatially multiplexed.

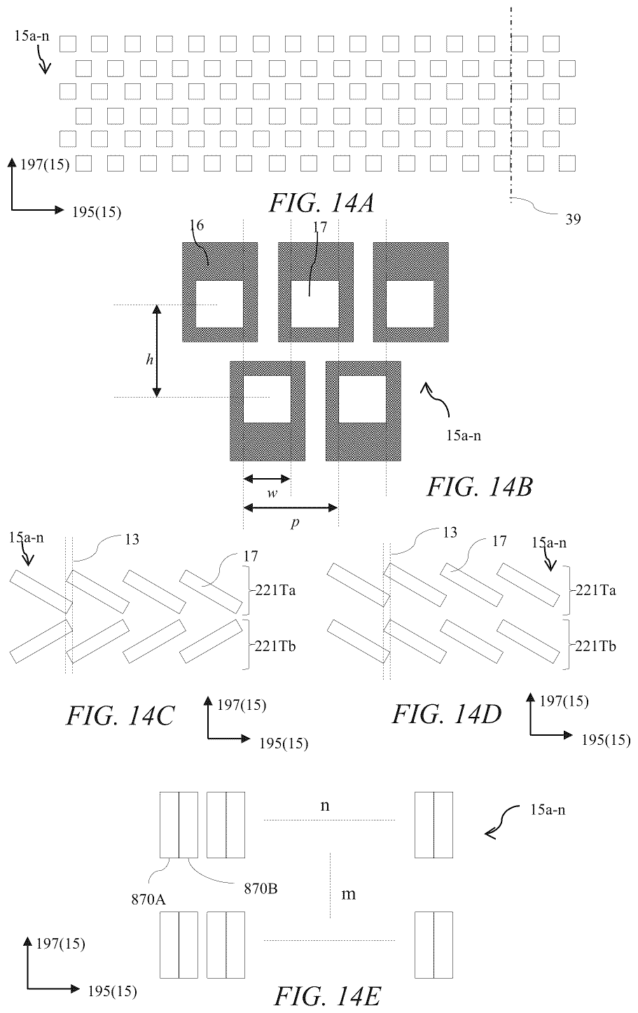

FIG. 14A is a schematic diagram illustrating in front view a light detector array 15a-n comprising contiguous columns of light detectors 15 for use in the directional detection device 200 of FIGS. 12A-C and FIG. 13A. Features of the embodiment of FIG. 14A not discussed in further detail may be assumed to correspond to the features with equivalent reference numerals as discussed above, including any potential variations in the features.

In the alternative embodiment of FIG. 14A, the light detectors 15a-n may comprise a staggered array of emitting apertures 17 that may be defined by emitting element 230 size or by the wells 234 of colour converted LEDs as described elsewhere herein. Non-emitting regions 37 are provided between the emitting apertures. The array of light detectors 15a-n have an arrangement such that an intensity of light emitted by the light detectors 15a-n summed along each line 39 through the light detectors 15a-n in the transverse direction 197 is the same. The uniformity across a one-dimensional array of detection optical cones 26a-n, for example as illustrated in FIG. 12A may be increased.

Advantageously the detection optical cones 26a-n may be provided with high uniformity in the lateral direction 195 in arrangements wherein the packages 16 are physically separated by gaps on a PCB. Advantageously the cost and complexity of the light detector 15a-n arrangement may be reduced while achieving desirable uniformity across the respective light cones 26a-n.

FIG. 14B is a schematic diagram illustrating in front view an alternative light detector array comprising contiguous columns of light emitters for use in the directional detection device 200 of FIGS. 12A-C and FIG. 13A. Features of the embodiment of FIG. 14B not discussed in further detail may be assumed to correspond to the features with equivalent reference numerals as discussed above, including any potential variations in the features.

In the alternative embodiment of FIG. 14B, the light sources may be arranged in two rows of light sources. Advantageously the cost and complexity of assembly and addressing may be reduced. The light detectors 15a-n each comprise a package 16 and light emitting aperture 17 that may be a white light emitting region or may be some other colour, for example red for rear vehicle light detectors. The colour of the light detectors 15a-n may be the same across the array. Advantageously the output detection profiles may have uniform colour.

In an alternative embodiment the colour of the light detectors 15a-n may vary with lateral location across the output face 22. For example some light sources may have different colour temperatures or peak wavelengths, such that the angular profiles may vary in colour with angle. Advantageously different regions of the illuminated scene may be provided with different colours to increase visual differentiation of scenes.

It would be desirable to provide a uniform detection profile across adjacent detection optical cones 26a-n. Such a uniform profile may be provided by providing at least some of the light detectors 15 that are contiguous in the direction laterally across waveguide 1. At least some of the light detectors 15 are separated by distance h in the direction perpendicular to the direction laterally across the waveguide 1 (x-axis). The light detectors 15 are arranged in two rows and are offset so that the pitch p of the light detectors 15 is twice the width w of the emitting regions. Advantageously the emitting apertures 17 are contiguous in the direction laterally across waveguide 1 and detection optical cones 26a-n are provided with contiguous angular profiles.

Further the packages 16 have non-emitting regions that may be larger than the thickness of the waveguide 1. Such non-emitting regions may be provided to extend away from the surfaces 6, 8. Advantageously desirable sized heat-sink and control components may be provided within the packages 16 while achieving contiguous angular profiles of cones 26.

FIGS. 14C-D are schematic diagrams illustrating in front view a light detector array 15a-n comprising columns of overlapping light detectors 15 for use in the directional detection device 200 of FIGS. 12A-C and FIG. 13A. Features of the embodiments of FIGS. 14C-D not discussed in further detail may be assumed to correspond to the features with equivalent reference numerals as discussed above, including any potential variations in the features.

In comparison to the embodiment of FIG. 14A, the light emitting apertures 17 of the light detectors 15a-n are rotated so at the edges of the light sources provide an overlap region 13 between adjacent rows 221Ta, 221Tb so that the light emitted by the light detectors 15a-n summed along each line through the light detectors 15a-n in the transverse direction 197 is the same. The uniformity across a one-dimensional array of detection optical cones 26a-n, for example as illustrated in FIG. 12A may be increased.

Light detectors for a LIDAR phase detection system will now be described.

FIG. 14E is a schematic diagram illustrating in front view an alternative light detector array comprising detector pairs 870A, 870B. Features of the embodiment of FIG. 14E not discussed in further detail may be assumed to correspond to the features with equivalent reference numerals as discussed above, including any potential variations in the features.

Each spatial position in the array of light detectors 15a-n is split into two parts, part 870A, and part 870B. The parts 870A, 870B are shown as split vertically but could be split in different arrangements. In a further alternative the parts 870A, 870B are not physically split as shown but adjacent pairs of full pixels (horizontal or vertical) are processed as described below for the parts 870A, 870B.

Part 870A is logically gated “on” with a signal in phase with the illumination pulses, i.e. it only detects received light when in phase with the illumination pulse. The directional detection device 100 is arranged to receive some light from the illumination light source 174, for example as illustrated in FIG. 8 hereinabove.

Pixel part 870B is logically gated “on” with a signal out of phase with the illumination pulses, so as to detect received light only during the positive parts of the gating signal. In the illustration of FIG. 15A-F hereinbelow the out-of-phase signal is shown as 180 degrees or in antiphase with the illumination signal, however other phase arrangements such as 90 degrees out of phase could be used.

After thresholding the reflected light signals to reduce noise, the difference in signals of the part 870A, and part 870B represents a phase difference of the reflected signal from the illumination signal and therefore represents the distance of the object in the scene imaged at that pixel location.

Phase detection for a LIDAR system will now be described.

FIG. 15A is a schematic timing diagram illustrating waveform 852 of detected output light 850 from a LIDAR light source; FIG. 15B is a schematic timing diagram illustrating waveform 856 of detected light 854 received from a remote scene; FIG. 15C is a schematic timing diagram illustrating the waveform 853 in-phase illumination light logic state 851; FIG. 15D is a schematic timing diagram illustrating waveform 858 of detected light gated (ANDed) with in-phase illumination light logic state 857;

FIG. 15E is a schematic timing diagram illustrating the waveform 862 of antiphase illumination light logic state 860; and FIG. 15F is a schematic timing diagram illustrating the waveform 866 of detected light gated (ANDed) with antiphase illumination light logic state 864. Features of the embodiment of FIGS. 15A-F not discussed in further detail may be assumed to correspond to the features with equivalent reference numerals as discussed above, including any potential variations in the features.

Light pulse waveform 852 is emitted from the source 174, which may be a laser such as a VCSEL, with luminous flux output 850. The detected luminance 854 after reflecting from an object in the scene is shown by waveform 856 which lags the light pulse waveform 852 by a phase difference phi. A logic signal 851 in phase with the light pulse waveform 852 is shown by waveform 853. The waveform 856 may then be thresholded to reduce noise, converted to a logic level and then logically ANDed with the waveform 853 to produce detected signal A, 857 with waveform 858.

The waveform 858 will repeat with every positive pulse of the light pulse waveform 852. A logic signal 860 in antiphase with the illumination light pulse waveform 852 is shown by waveform 862. The waveform 856 may then be thresholded to reduce noise, converted to a logic level and then logically ANDed with waveform 862 to produce detected signal B, 864 with waveform 866.

The magnitude of the difference between the detected signal from detector 870A, 857 and the detected signal 864 at detector 870B, represents a measurement of the phase difference Δϕ of the detected luminance 854 from the light pulse waveform 852, which in turn represents the distance of the object at that pixel position reflecting light in the scene. Similar calculation can be done for all the detectors in the array of detectors 15a-n to construct a depth map of the scene.

It may be desirable to provide a camera with low thickness.

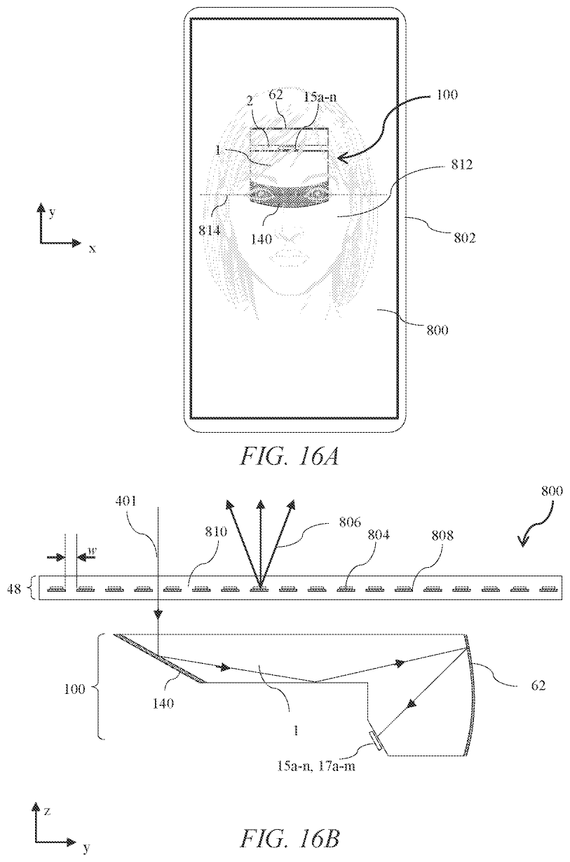

FIG. 16A is a schematic diagram illustrating in front view a display apparatus 800 comprising a directional detection device 100 arranged under (behind) the spatial light modulator 48; and FIG. 16B is a schematic diagram illustrating in side view a display apparatus 800 comprising a directional detection device 100 arranged under (behind) the spatial light modulator 48. Features of the embodiments of FIGS. 16A-B not discussed in further detail may be assumed to correspond to the features with equivalent reference numerals as discussed above, including any potential variations in the features.

Display apparatus 800 comprises: a spatial light modulator 48 that is partially transparent and may for example comprise an emissive display such as an OLED or a microLED spatial light modulator 48. Image pixels 804 emit light 806 and may be arranged on a backplane comprising pixel 804 control electronics 808 and light transmitting apertures 810.

The directional light detection device 100 is arranged behind the spatial light modulator 48 so that the optical system 250 inputs light from the remote scene through the spatial light modulator 48.

In the alternative embodiment of FIGS. 16A-B, the directional light detection device 100 may be a camera, wherein the light detectors 15a-n are arranged to capture an image that is typically a colour image with the light detectors 15a-n are arranged to capture a colour image.

Display apparatus 800 is comprised within a cell phone 802 for example, wherein the display apparatus 800 has some light transmission, for example an OLED display such that light 401 is directed through the display apparatus 800 into the directional detection device 100. In alternative embodiments, the injection reflector 140 may be positioned outside the active area of the display apparatus 800.

By way of comparison with conventional cameras, for example those using refractive optics, the anamorphic optics of the directional light detection device 100 provides an increased light collection aperture by means of the injection reflector 140. The width, w of the apertures 810 may be reduced in comparison to conventional cameras, for a desirable luminous flux onto the array of light detectors 15a-n.

High capture efficiency may be achieved to advantageously compensate for the optical losses through the display apparatus 800. Pixel 804 size and packing density may be increased, or may be maintained uniformly across the spatial light modulator 48. The thickness of detection device 100 may be much lower than conventional cameras. The active area of the spatial light modulator 48 available for viewing may be increased.

The directional detection device 100 may also include one or more light emitting devices 17a-m adjacent to or interleaved with the array of detectors 15a-n.

The emitting devices 17a-m may produce directional illumination beams to function as a cell phone LIDAR to measure the distances in a scene, or for example to capture the geometry of a face 812, for example as illustrated in FIG. 15A-F. The emitting devices 17a-m and array of detectors 15a-n may cooperate with optics on-chip to enable the phase difference Δϕ between the emitted and reflected beams to be measured and the distances from the display apparatus 800 of objects in the scene calculated from that data.

The location of the injection reflector 140 may be arranged so that in operation for a video conferencing application, the location of light detection is close to the location of the eye line 814 of the displayed face 812. Gaze cues are maintained, advantageously improving perceived eye contact.

As may be used herein, the terms “substantially” and “approximately” provide an industry-accepted tolerance for its corresponding term and/or relativity between items. Such an industry-accepted tolerance ranges from zero percent to ten percent and corresponds to, but is not limited to, component values, angles, et cetera. Such relativity between items ranges between approximately zero percent to ten percent.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1. A directional light detection device comprising:
a light detection system comprising an array of light detectors distributed in a lateral direction; and
an optical system arranged to input light from a remote scene and direct the input light to the light detection system, wherein
the optical system comprises a waveguide that comprises:
front and rear guide surfaces arranged to guide the input light along the waveguide to the light detection system; and
an injection reflector arranged to reflect the input light received through at least one of the guide surfaces and inject the input light into the waveguide for guiding by the front and rear guide surfaces, wherein the injection reflector has positive optical power in the lateral direction.

2. A directional light detection device according to claim 1, wherein the directional light detection device is an anamorphic directional light detection device, wherein
the optical system has an optical axis and has anamorphic properties in the lateral direction and a transverse direction that are perpendicular to each other and perpendicular to the optical axis, and
the optical system further comprises a transverse anamorphic component having positive optical power in the transverse direction, wherein the transverse anamorphic component is arranged to receive the light that has been guided between the front and rear guide surfaces before the light is directed to the light detection system.

3. A directional light detection device according to claim 2, wherein the optical system comprises an output section comprising an output reflector that is the transverse anamorphic component and is arranged to reflect the light that has been guided between the front and rear guide surfaces and direct it to the light detection system.

4. A directional light detection device according to claim 3, wherein the transverse anamorphic component further comprises a lens.

5. A directional light detection device according to claim 3, wherein
the output section further comprises an output face disposed on a front or rear side of the waveguide and facing the output reflector, the light detection system being arranged to receive light output through the output face of the output section, and
the output section is arranged to direct the light that has been guided between the front and rear guide surfaces through the output face to the light detection system.

6. A directional light detection device according to claim 5, wherein the output face extends at an acute angle to the front guide surface in the case that the output face is on the front side of the waveguide or to the rear guide surface in the case that the output face is on the rear side of the waveguide.

7. A directional light detection device according to claim 5, wherein the output face extends parallel to the front guide surface in the case that the output face is on the front side of the waveguide or to the rear guide surface in the case that the output face is on the rear side of the waveguide.

8. A directional light detection device according to claim 7, wherein the output face is coplanar with the front guide surface in the case that the output face is on the front side of the waveguide or with the rear guide surface in the case that the output face is on the rear side of the waveguide.

9. A directional light detection device according to claim 5, wherein the output face is disposed outwardly of one of the front or rear guide surfaces.

10. A directional light detection device according to claim 9, wherein the output section further comprises a separation face extending outwardly from the one of the front or rear guide surfaces to the output face.

11. A directional light detection device according to claim 3, wherein the output section is integral with the waveguide.

12. A directional light detection device according to claim 3, wherein
the waveguide has an end that is an output face that is arranged to output the light that has been guided between the front and rear guide surfaces, and
the output section is a separate element from the waveguide that further comprises an input face and is arranged to receive the light output from the waveguide through the input face.

13. A directional light detection device according to claim 2, wherein the transverse anamorphic component comprises a lens, that is optionally a compound lens.

14. A directional light detection device according to claim 13, wherein the waveguide has an end that is an output face that is arranged to output the light that has been guided between the front and rear guide surfaces, the light detection system being arranged to receive the light output through the output face of the waveguide.

15. A directional light detection device according to claim 14, wherein the transverse anamorphic component is disposed outside the waveguide, and the light detection system is arranged to direct light towards the waveguide through the transverse anamorphic component.

16. A directional light detection device according to claim 14, wherein the direction of the optical axis through the transverse anamorphic component is inclined at an acute angle with respect to the front and rear guide surfaces of the waveguide.

17. A directional light detection device according to claim 14, wherein the output face is inclined at an acute angle with respect to the front and rear guide surfaces of the waveguide.

18. A directional light detection device according to claim 1, wherein the optical system has no optical power in a transverse direction that is perpendicular to the lateral direction.

19. A directional light detection device according to claim 1, wherein the waveguide has an end that is an output face that is arranged to output the light that has been guided between the front and rear guide surfaces, the light detection system being arranged to receive the light output through the output face of the waveguide.

20. A directional light detection device according to claim 1, wherein the injection reflector is an end of the waveguide.

21. A directional light detection device according to claim 1, wherein at least one of an output face, the transverse anamorphic component and the array of light detectors has a curvature in the lateral direction that compensates for field curvature of the injection reflector.

22. A directional light detection device according to claim 1, wherein the front and rear guide surfaces of the waveguide are planar and parallel.

23. A directional light detection device according to claim 1, wherein the array of light detectors are also distributed in the transverse direction.

24. A directional light detection device according to claim 23, wherein the array of light detectors have pitches in the lateral and transverse directions with a ratio that is the same as the inverse of the ratio of optical powers of the lateral and transverse anamorphic optical elements.

25. A directional light detection device according to claim 1, wherein the injection reflector is arranged to reflect the input light received through the front guide surface.

26. A directional light detection device according to claim 1, further comprising a light source arranged behind the rear guide surface of the waveguide to input light through the waveguide.

27. A directional light detection device according to claim 26, wherein the light source is arranged to input infra-red light.

28. A directional light detection device according to claim 1, wherein the light detectors are arranged to detect infra-red light.

29. A directional light detection device according to claim 1, being a light detection and ranging apparatus, wherein
the directional light detection device further comprises a light source arranged to output infra-red light for illumination of the remote scene;
the light detectors are arranged to detect infra-red light; and
the directional light detection device further comprises a control system that is arranged to detect geometry of the remote scene from the light detected by the light detectors.

30. A directional light detection device according to claim 1, being a camera, wherein the light detectors are arranged to capture an image.

31. A directional light detection device according to 30, wherein the light detectors are arranged to capture a colour image.

32. A display apparatus comprising:
a spatial light modulator that is partially transparent; and
a directional light detection device according to claim 30, wherein the directional light detection device is arranged behind the spatial light modulator so that the optical system inputs light from the remote scene through the spatial light modulator.
